(19) United States
(12) Patent Application Publication
(10) Pub. No.: US 2008/0253827 A1
(43) Pub. Date: Oct. 16, 2008

(54) LEVER-ARCH TYPE FILE MECHANISM

(76) Inventors: Chun Yuen TO, Hong Kong (CN); Hung Yu CHENG, Hong Kong (CN); Yong YANG, Sui Zhou City (CN)

Correspondence Address: OSTROLENK FABER GERB & SOFFEN, 1180 AVENUE OF THE AMERICAS, NEW YORK, NY, 100368403, US

(21) Appl. No.: 11/866,025

(22) Filed: Oct. 2, 2007

(30) Foreign Application Priority Data
Apr. 11, 2007 (EP) 07251548.9

(51) Int. Cl. B42F 3/00

(52) U.S. Cl. 402/6

(57) ABSTRACT

A lever-arch type file mechanism is disclosed as including a base; two rings extending upwardly from the base, each ring including a post fixed to the base and an arch portion movable relative to the base and the post; a lever assembly movable relative to the base between two stable positions to pivot the arch portions relative to the post to selectively move the rings between a ring-closed configuration and a ring-open configuration; in which the lever assembly includes an outer arm and an inner arm, and when the lever assembly is in a first of the two stable positions, the outer arm is movable relative to the inner arm member between an upper position and a lower position.

This invention relates to a device for retaining a stack of hole-punched paper in a file and, in particular such a device comprising a lever-arch type file mechanism.

In a conventional lever-arch type file mechanism, a one-armed lever is provided for pivoting a pair of arch elements relative to a pair of fixed posts to allow pieces of hole-punched paper to be retrieved from or inserted into the file mechanism, and for closing the posts and arch elements to form a pair of closed rings to retain the paper therein. The pair of arch elements are integrally formed with an intervening shaped portion on which a roller attached to the lever travels during pivotal movement of the lever, to effect opening or closing of the ring pairs.

In such a conventional file mechanism, when the ring pairs are open, the upper free end of the lever is very close to, and sometimes even contacts, one of the arch elements. Thus, when the ring pairs are open, paper can only be retrieved from or inserted into the pair of fixed posts, but no paper can be retrieved from or inserted into the pair of pivotable arch elements.

It is thus an object of the present invention to provide a lever-arch type file mechanism and a lever-arch type file with such a mechanism in which the aforesaid shortcomings are mitigated, or at least to provide a useful alternative to the public.

According to a first aspect of the present invention, there is provided a lever-arch type file mechanism including a base; at least two rings extending upwardly from the base, each said ring including a post member fixed to said base and an arch member movable relative to said base and said post member; a lever assembly movable relative to said base between two stable positions to pivot said arch members relative to said post members to selectively move said rings between a ring-closed configuration and a ring-open configuration; characterized in that said lever assembly includes at least a first arm member and a second arm member, and that when said lever assembly is in a first of said stable positions, said first arm member is movable relative to said second arm member between an upper position and a lower position.

According to a second aspect of the present invention, there is provided a lever-arch type file including a lever-arch type file mechanism fixedly secured to a substrate, said lever-arch type file mechanism including a base; at least two rings extending upwardly from the base, each said ring including a post member fixed to said base and an arch member movable relative to said base and said post member; a lever assembly movable relative to said base between two stable positions to pivot said arch members relative to said post members to selectively move said rings between a ring-closed configuration and a ring-open configuration; characterized in that said lever assembly includes at least a first arm member and a second arm member, and that when said lever assembly is in a first of said stable positions, said first arm member is movable relative to said second arm member between an upper position and a lower position.

Embodiments of lever-arch type file mechanisms according to the present invention will now be described, by way of examples only, with reference to the accompanying drawings, in which:

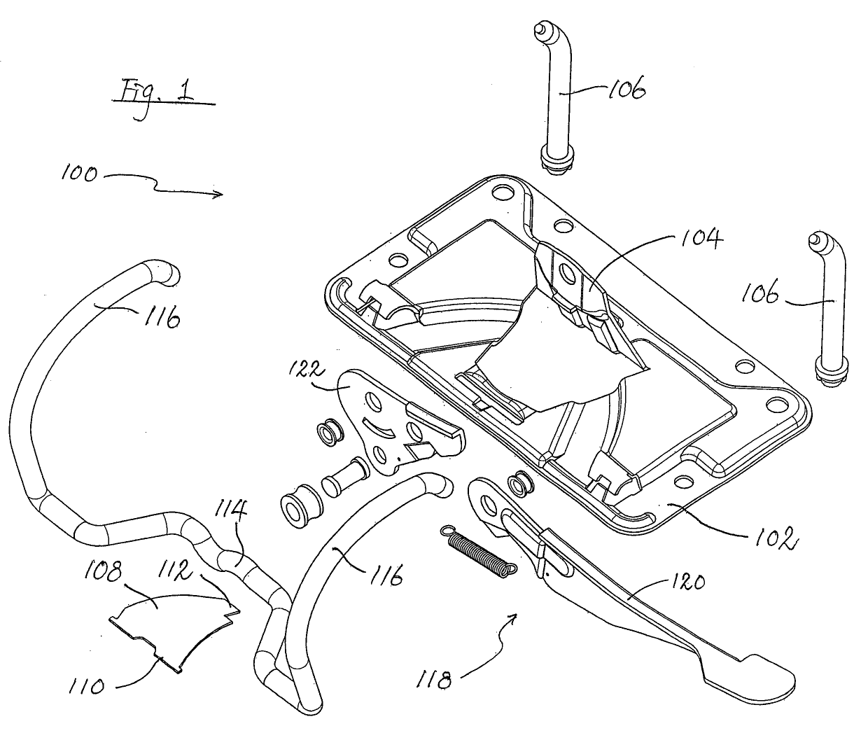

FIG. 1 is an exploded view of a lever-arch type file mechanism according to a first embodiment of the present invention;

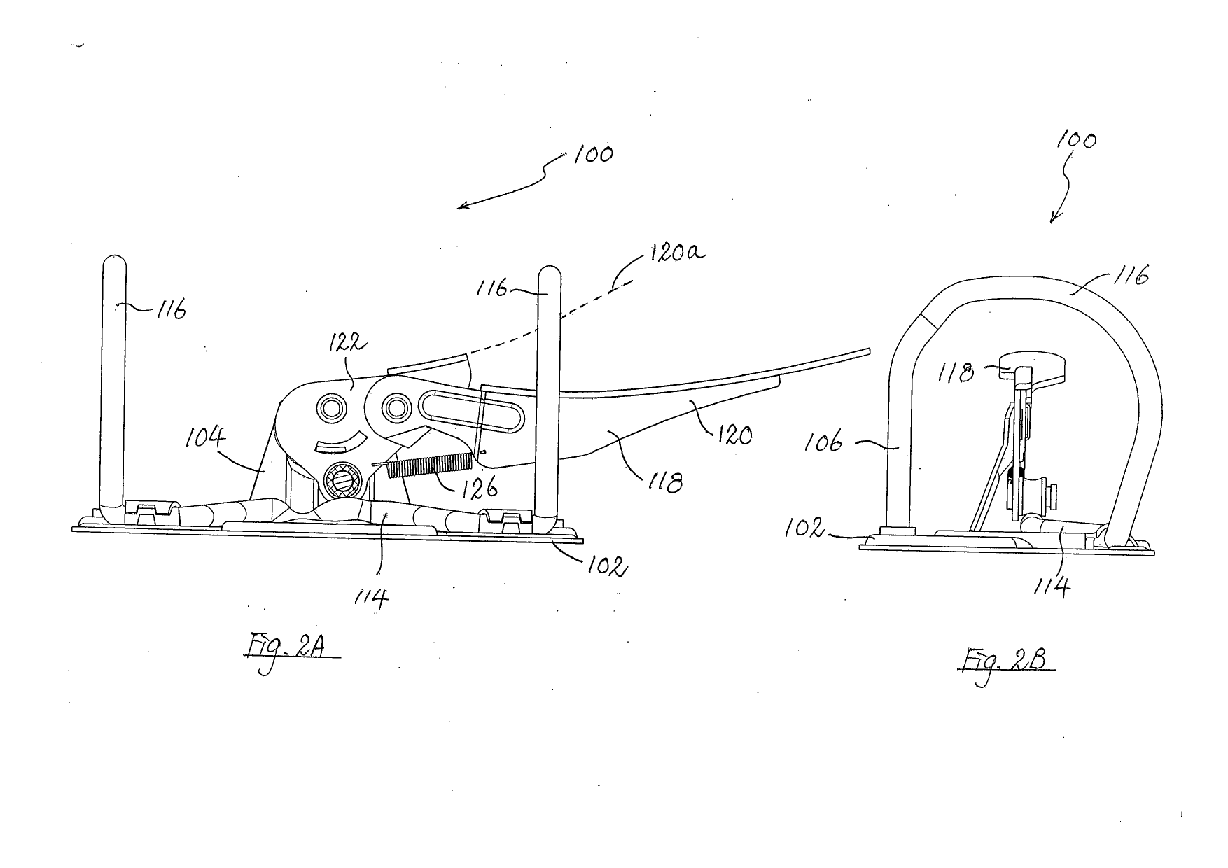

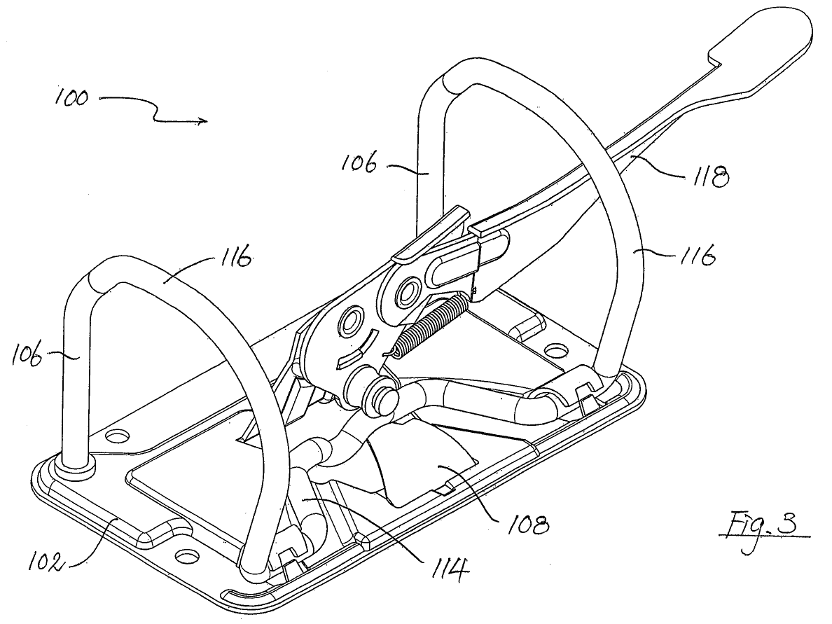

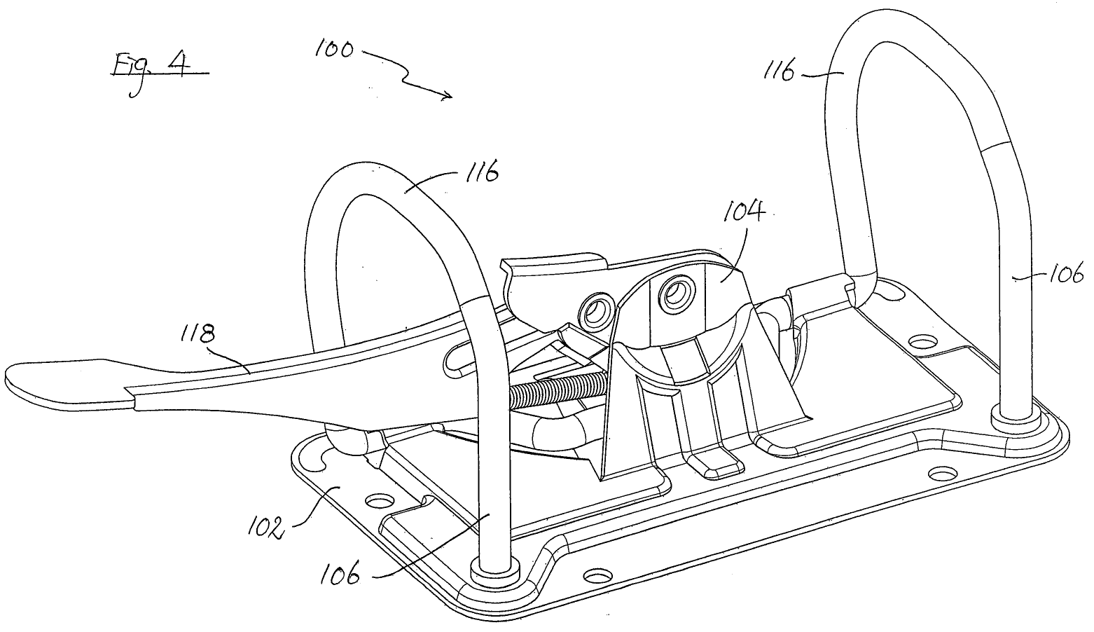

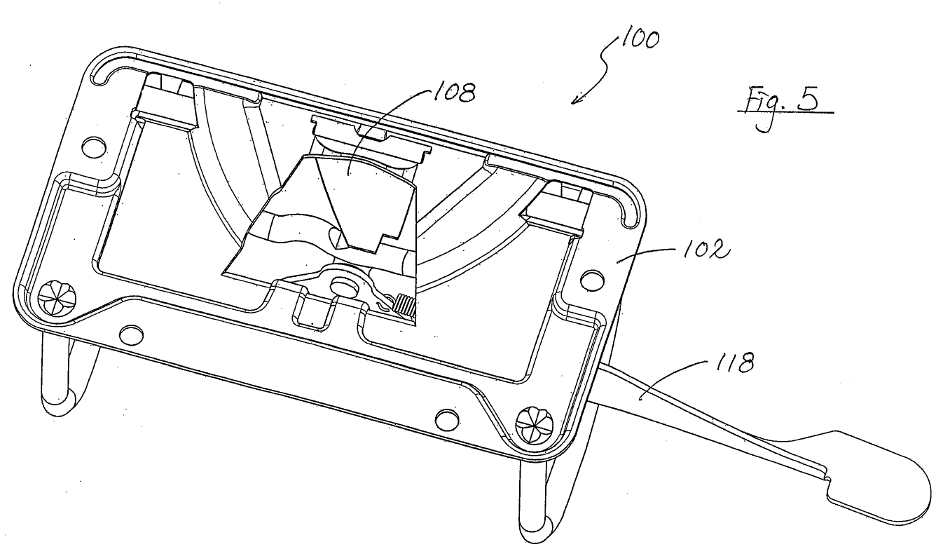

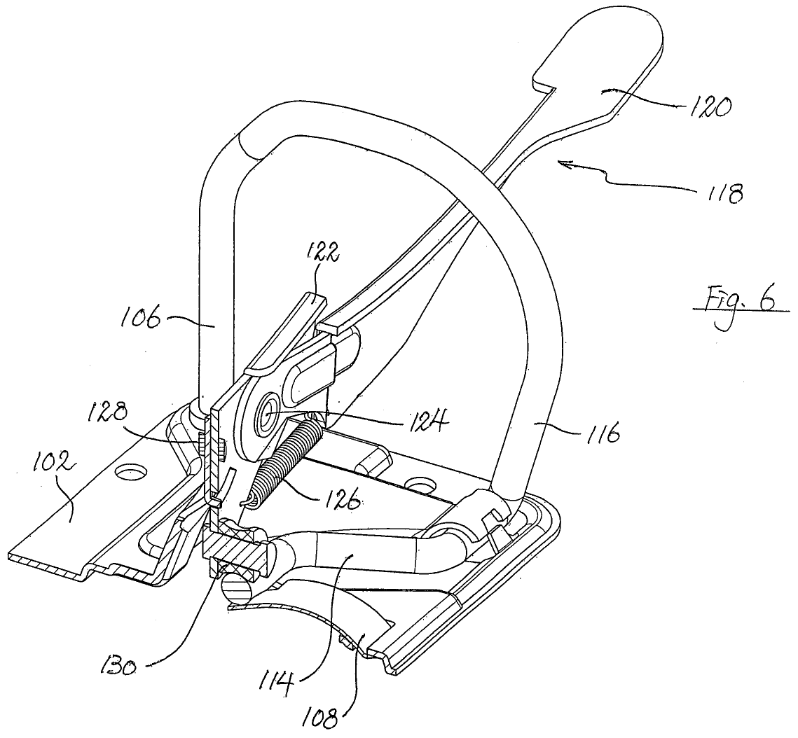

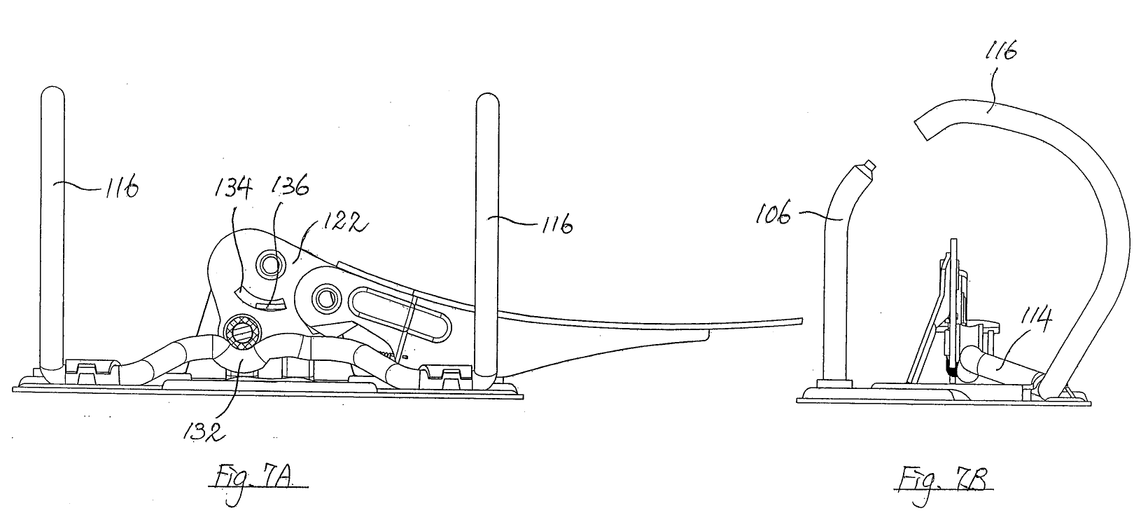

FIG. 2A is a front view of the file mechanism shown in FIG. I in a ring-closed configuration;

FIG. 2B is a side view of the file mechanism shown in FIG. 2A;

FIG. 3 is a front top perspective view of the file mechanism shown in FIG. 2A;

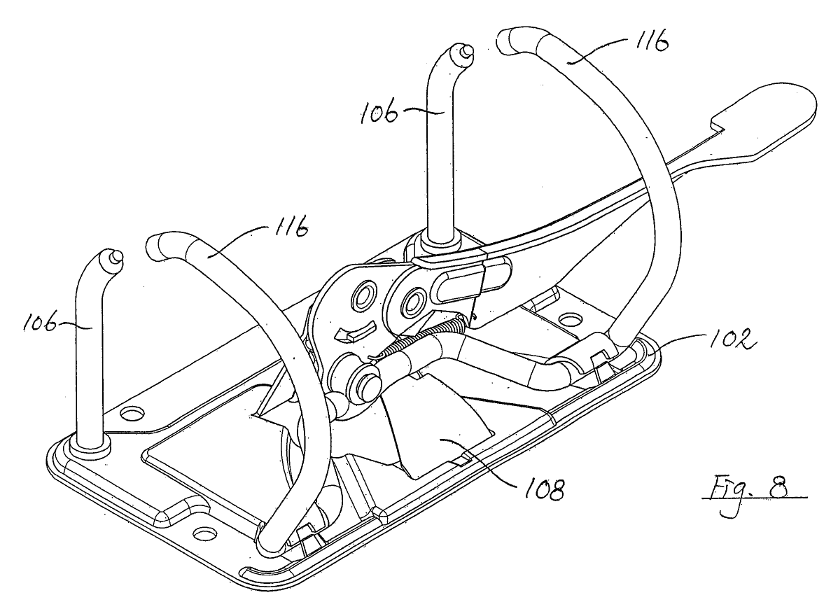

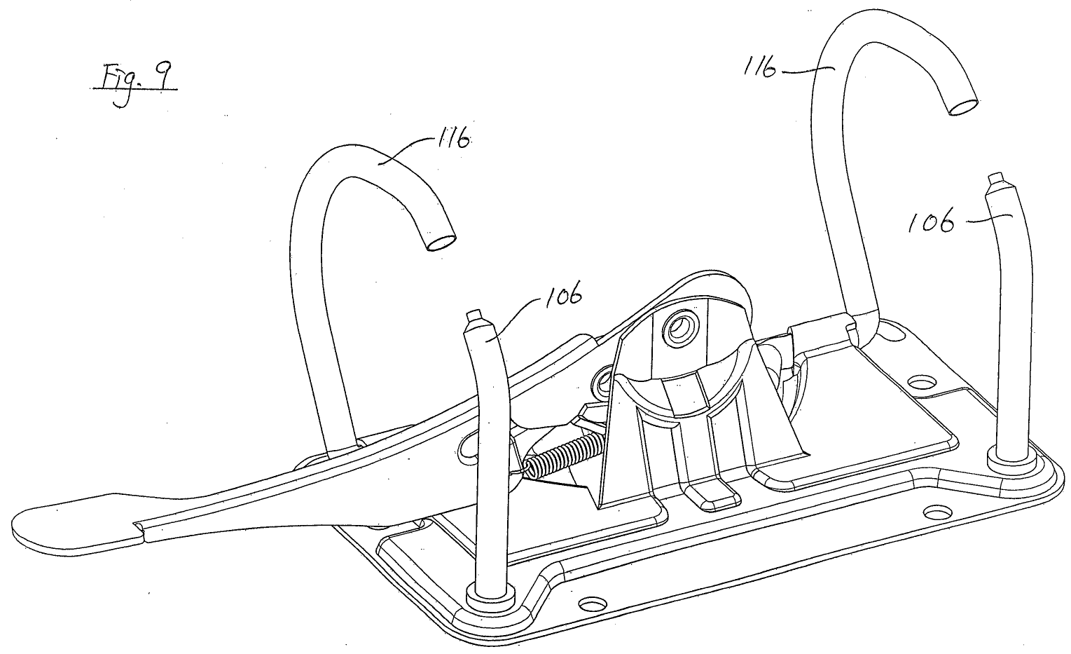

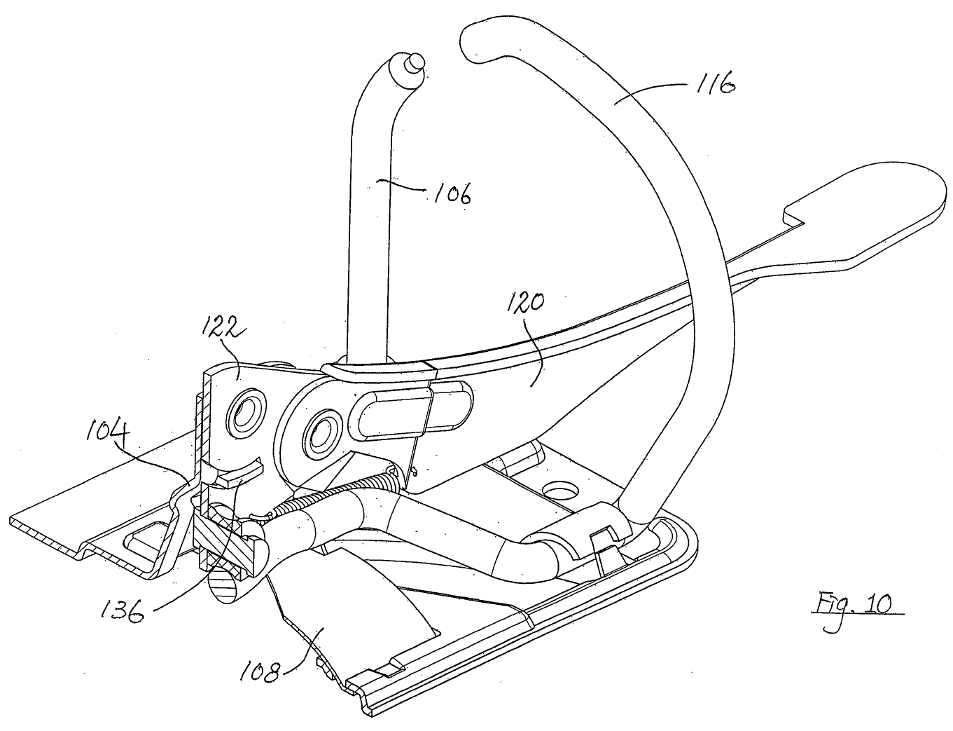

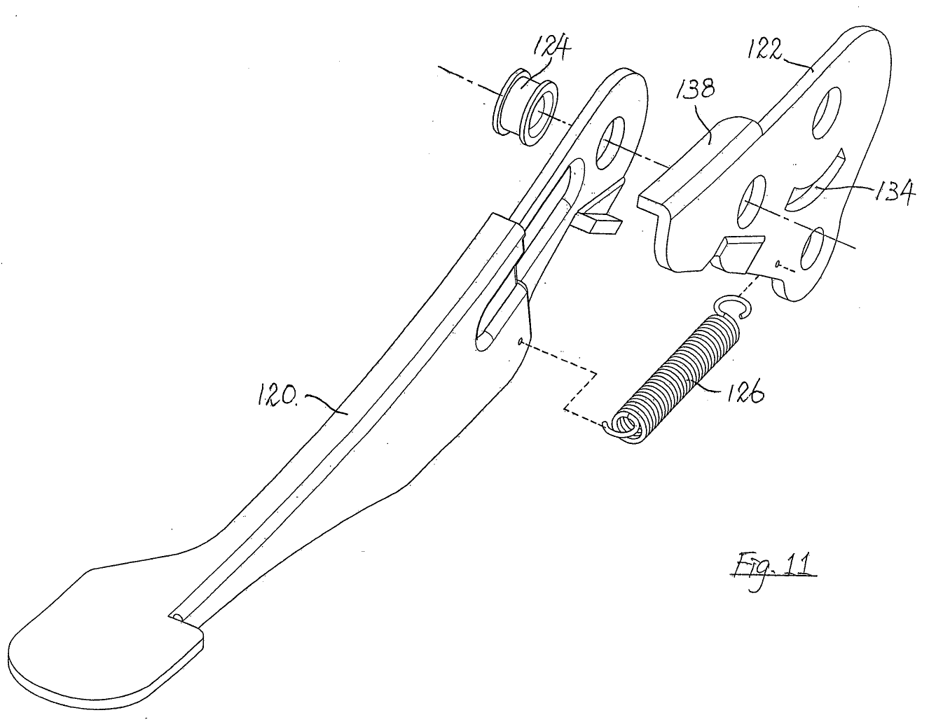

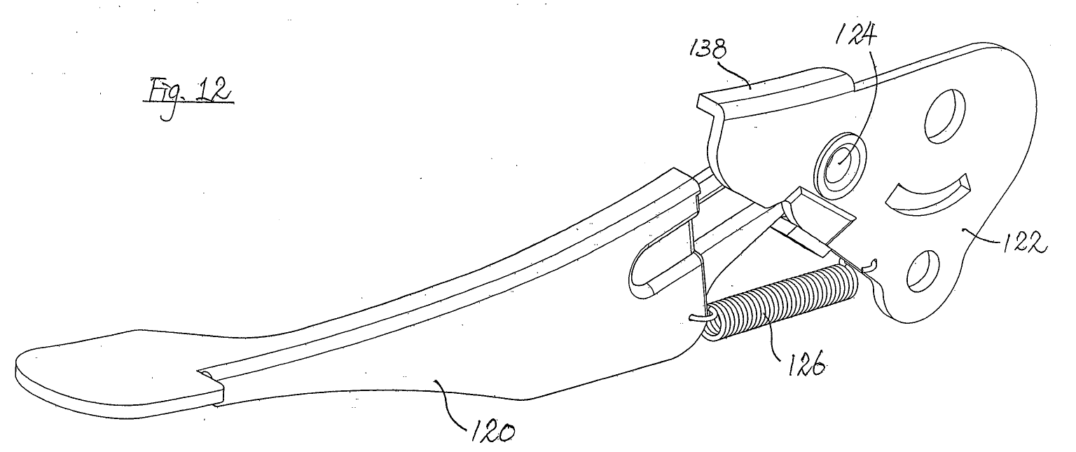

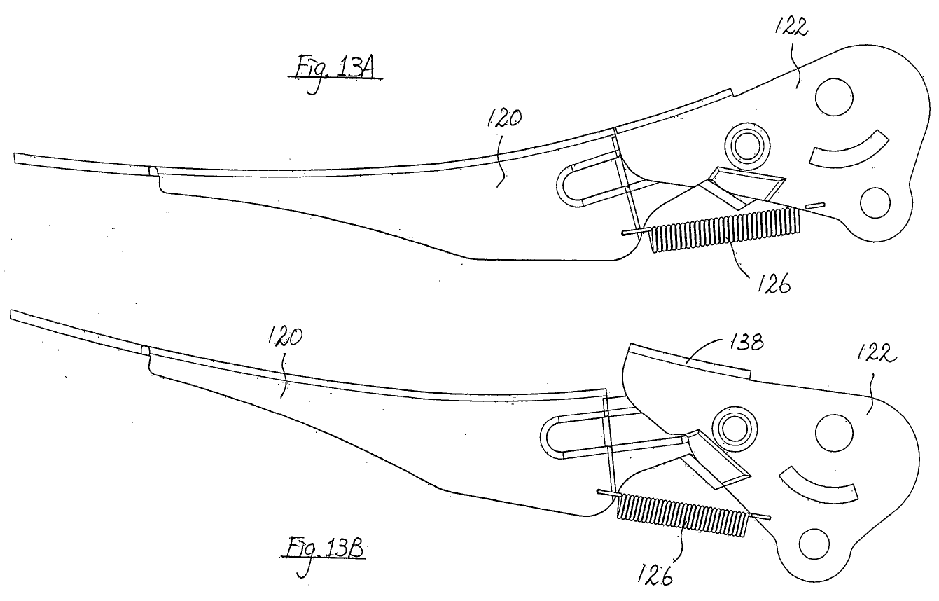

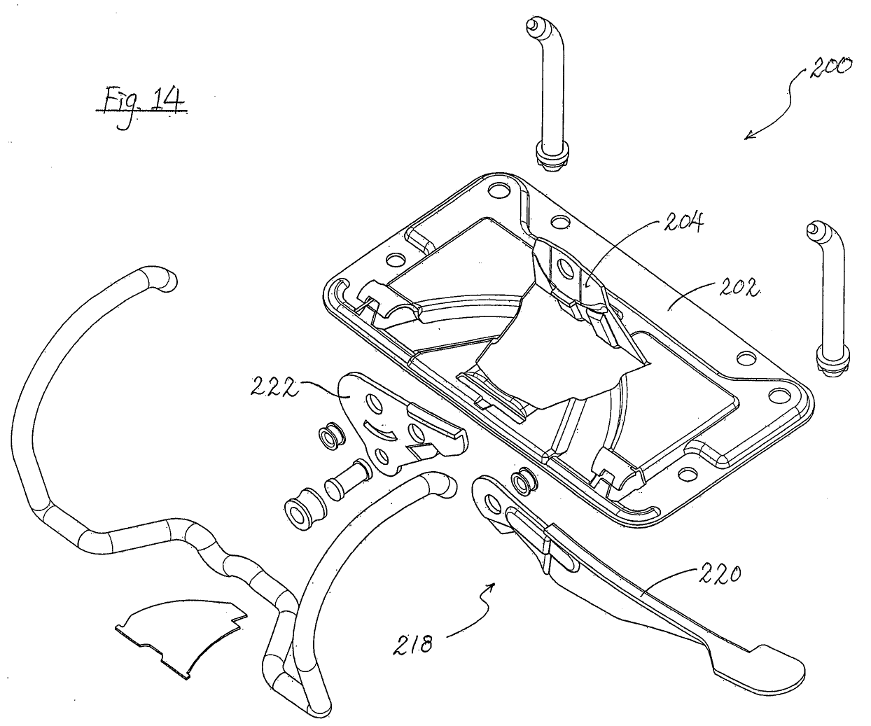

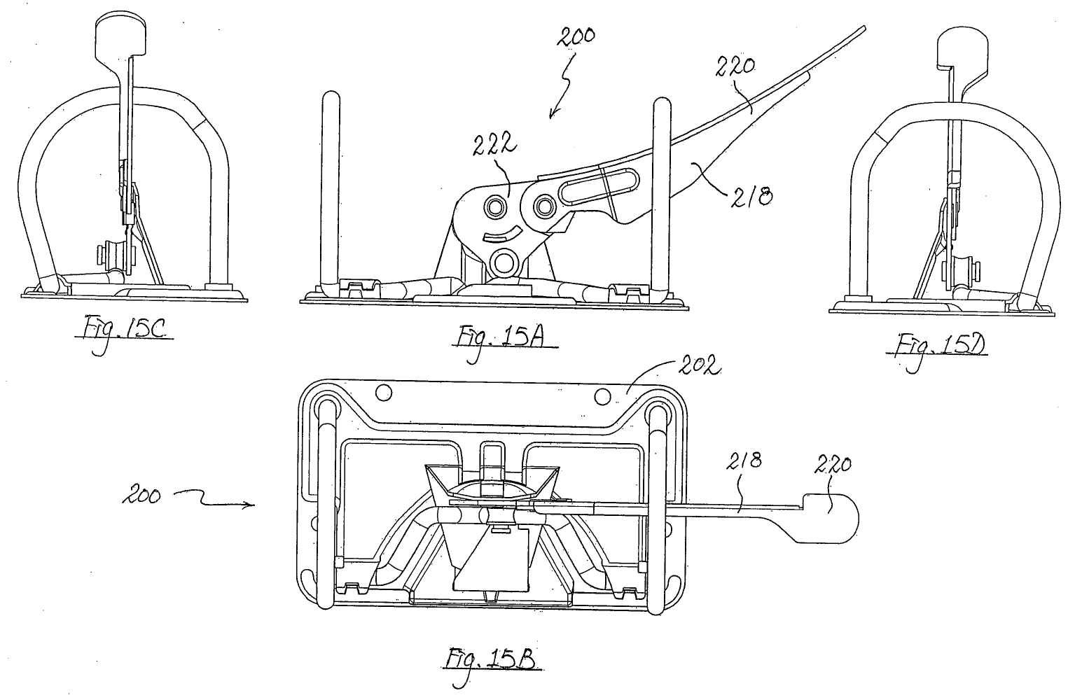

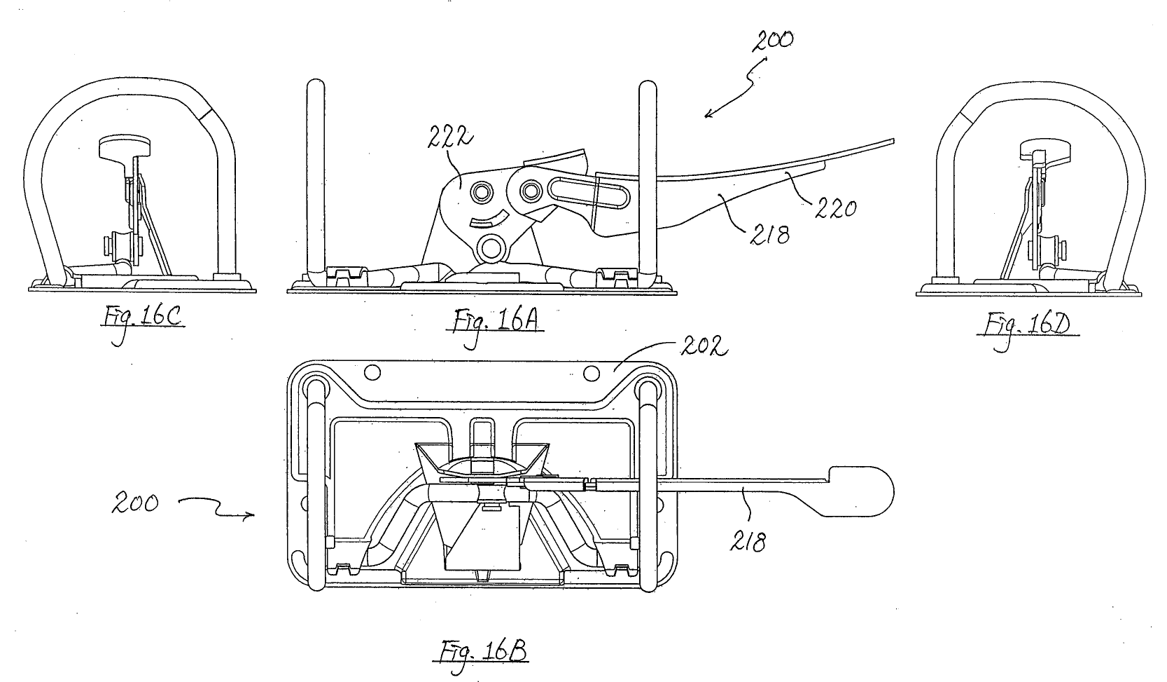

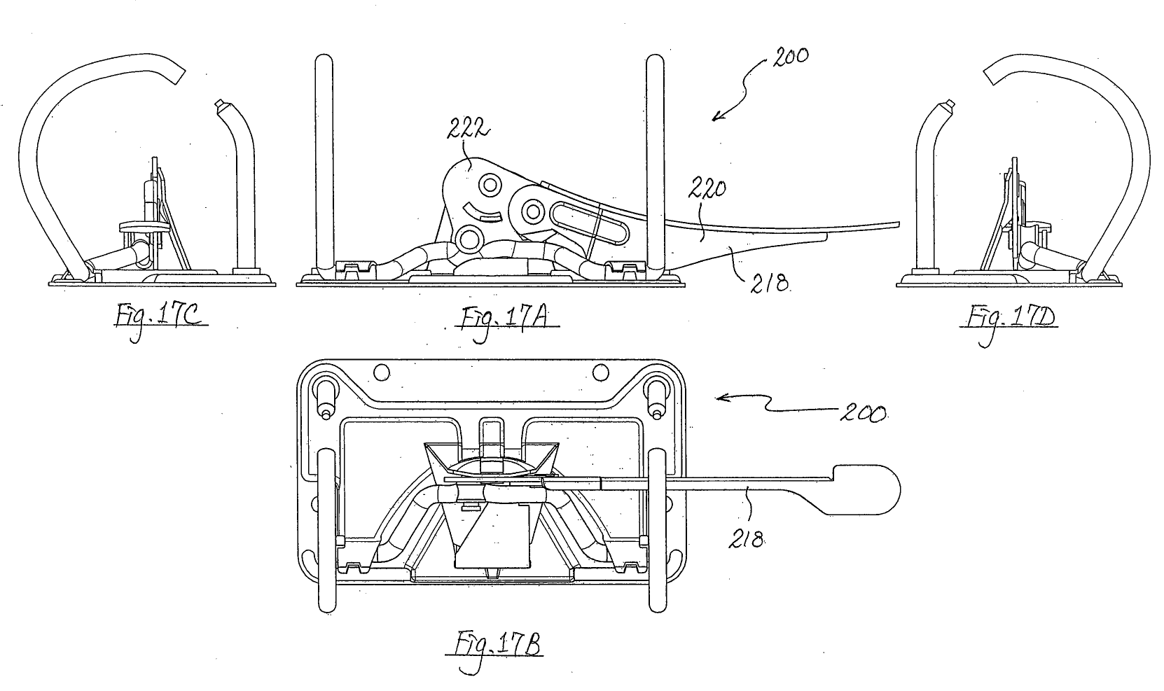

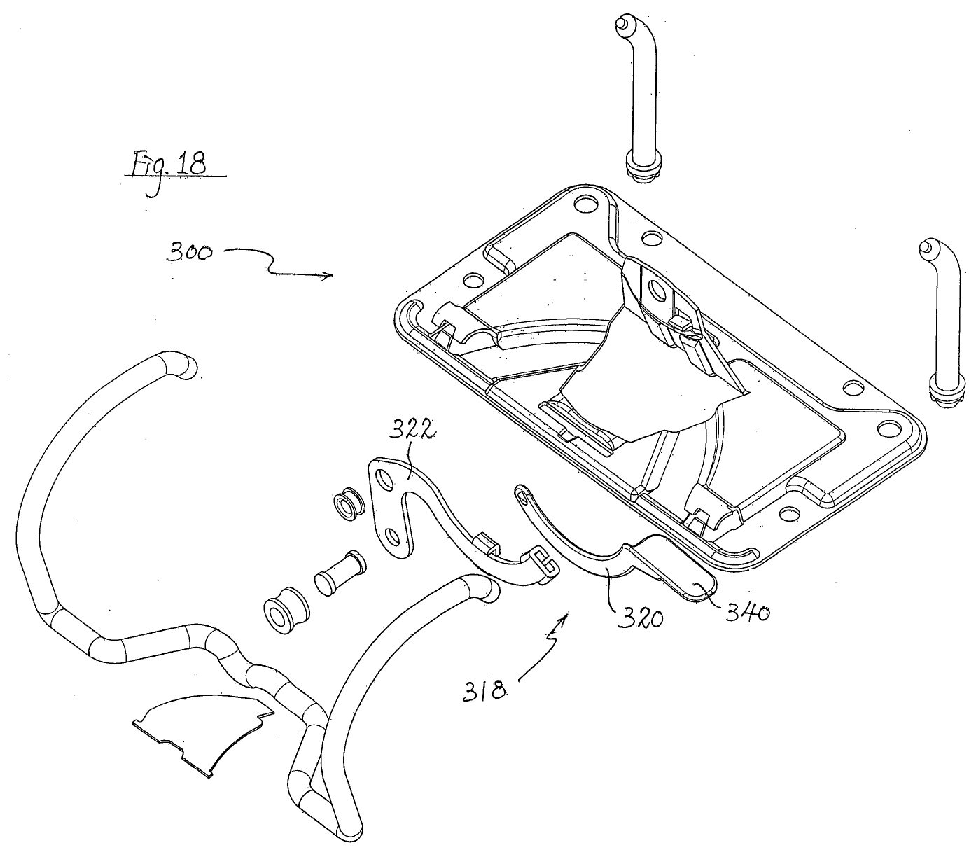

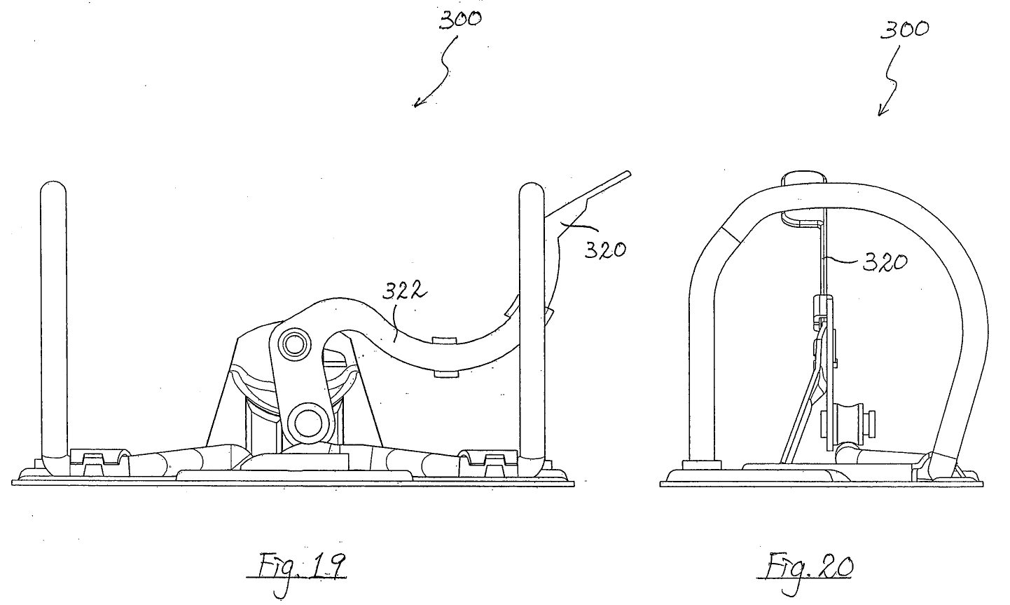

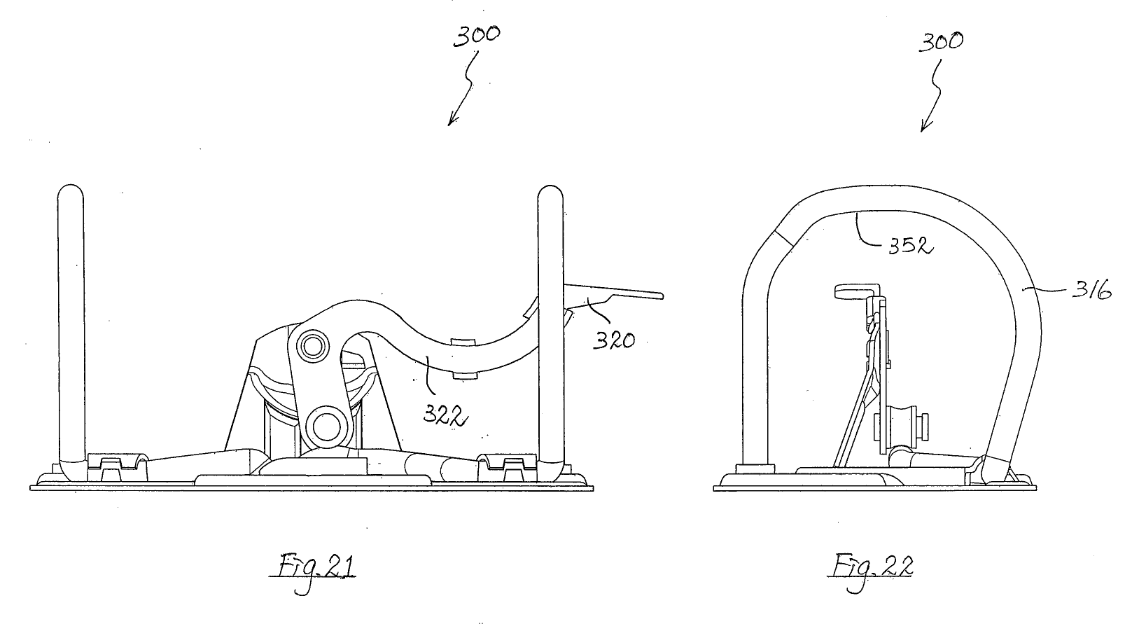

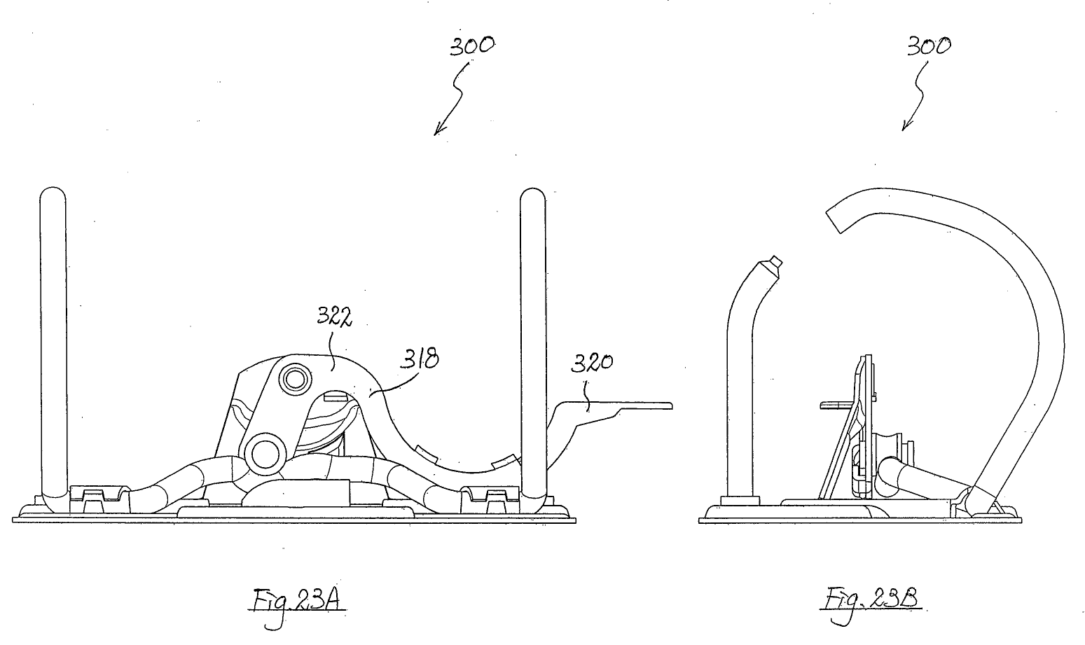

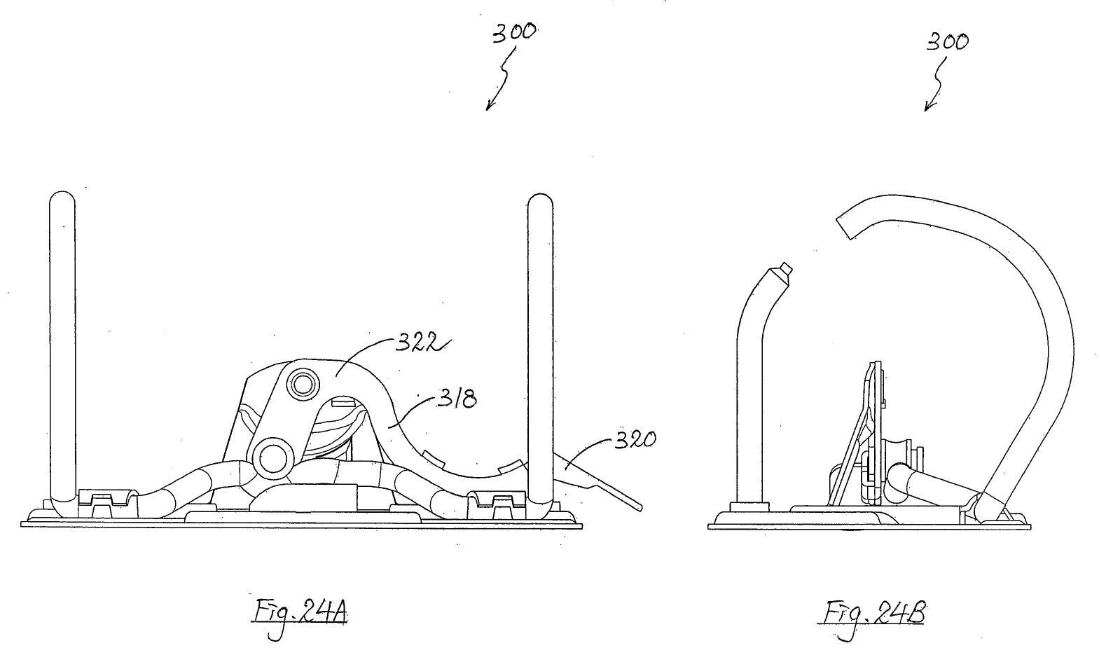

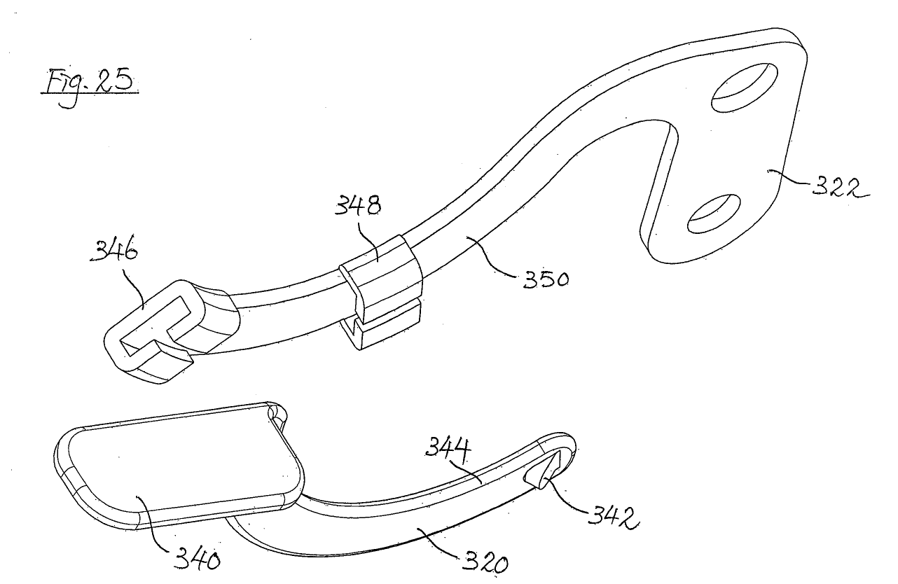

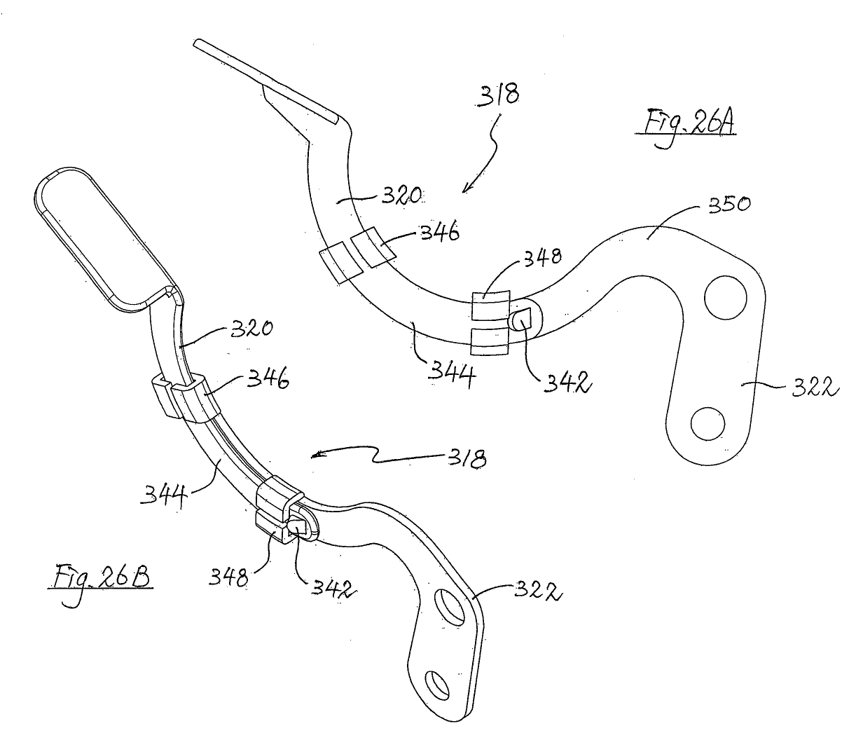

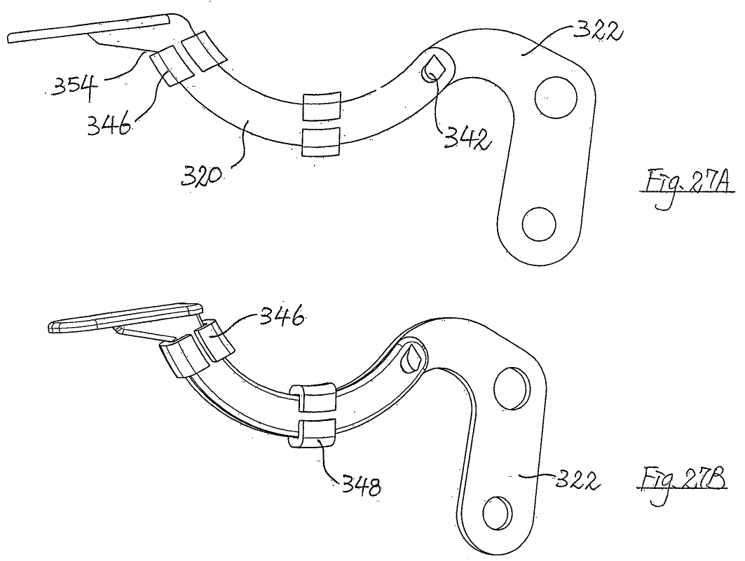

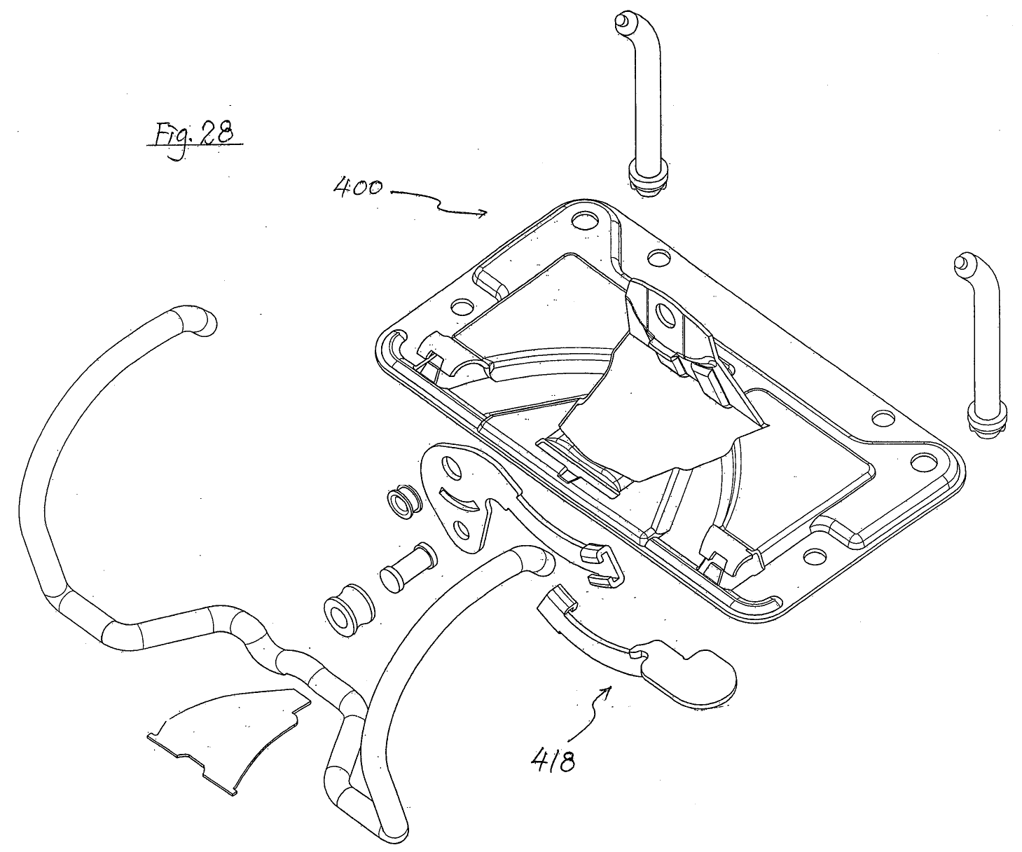

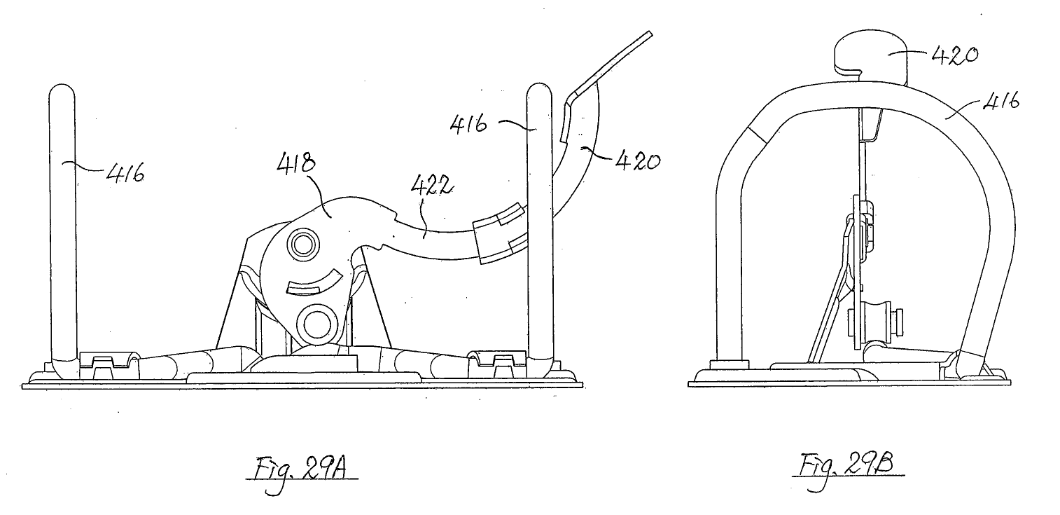

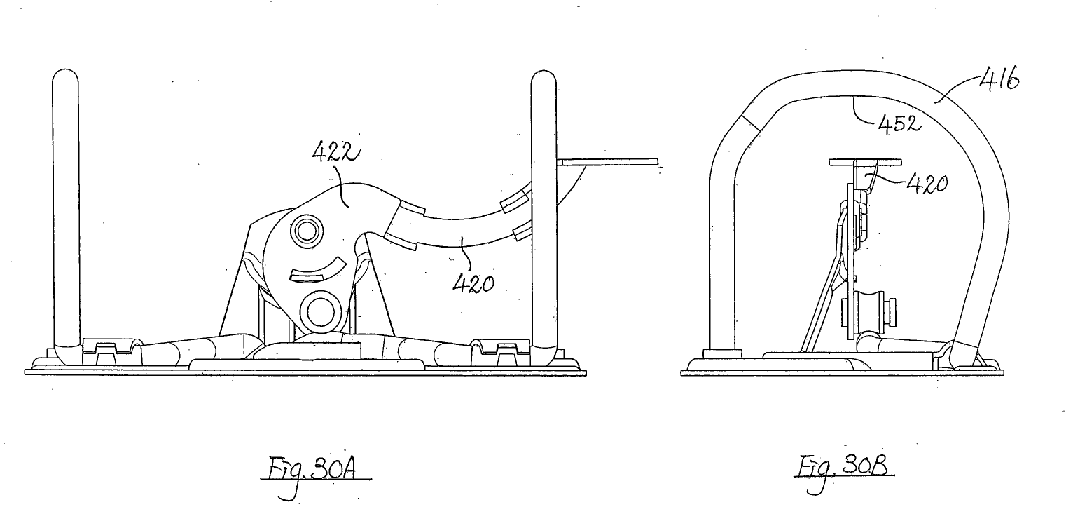

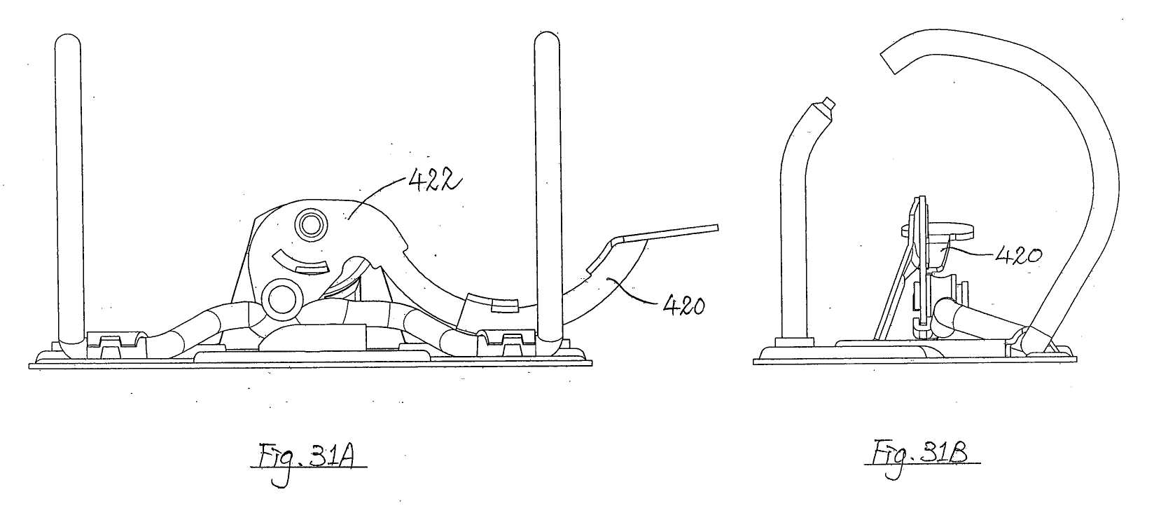

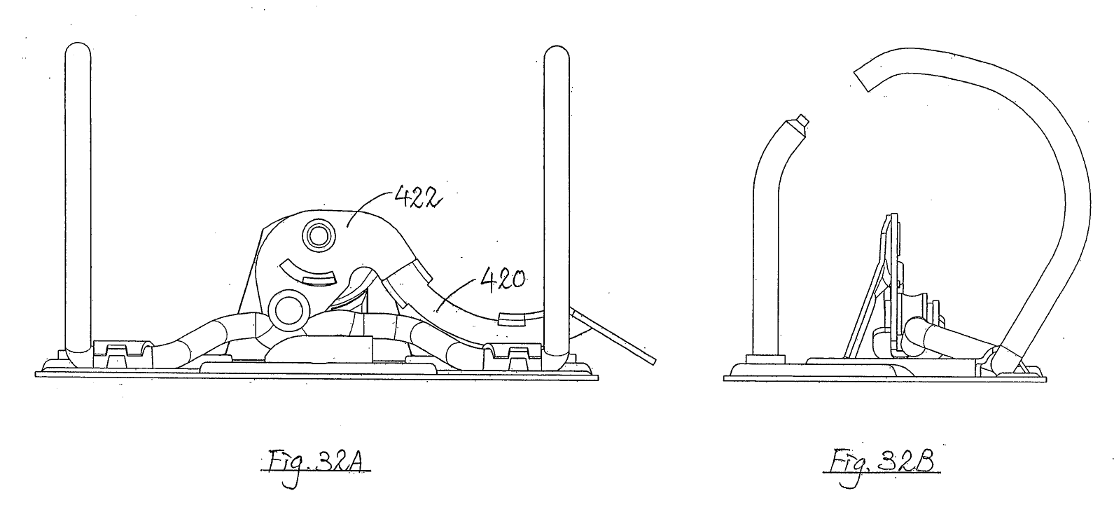

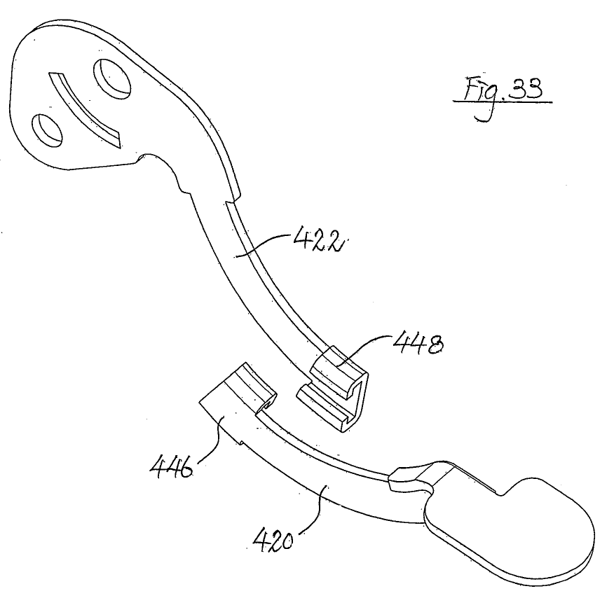

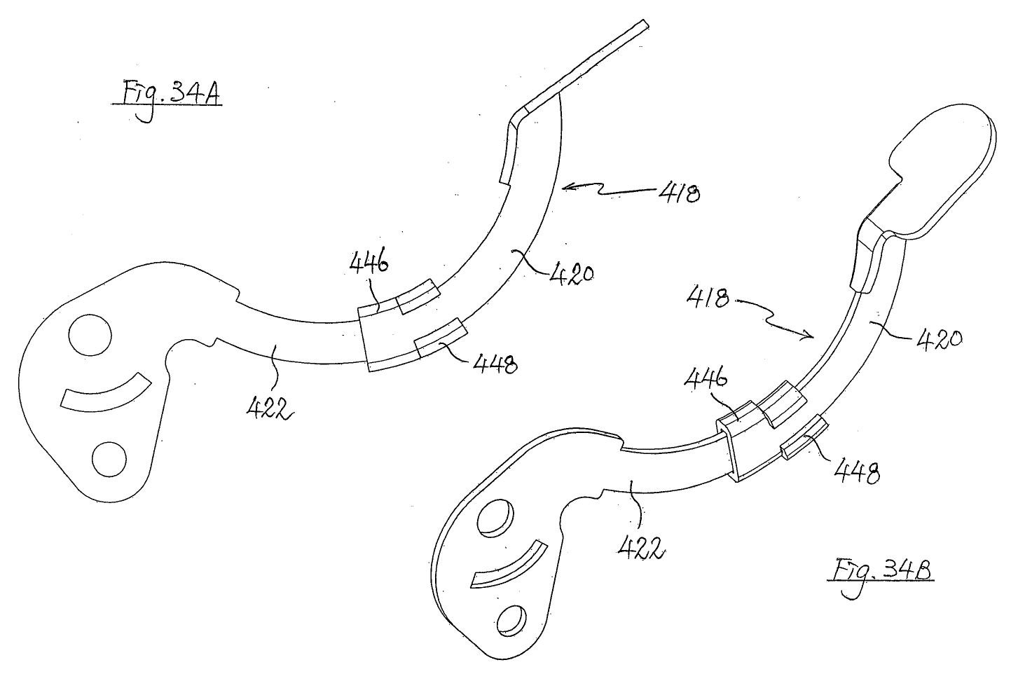

FIG. 4 is a rear top perspective view of the file mechanism shown in FIG. 3;

FIG. 5 is a bottom perspective view of the file mechanism shown in FIG. 3;

FIG. 6 is a sectioned top perspective view of the file mechanism shown in FIG. 3;

FIG. 7A is a front view of the file mechanism shown in FIG. 1 in a ring-open configuration;

FIG. 7B is a side view of the file mechanism shown in FIG. 7A;

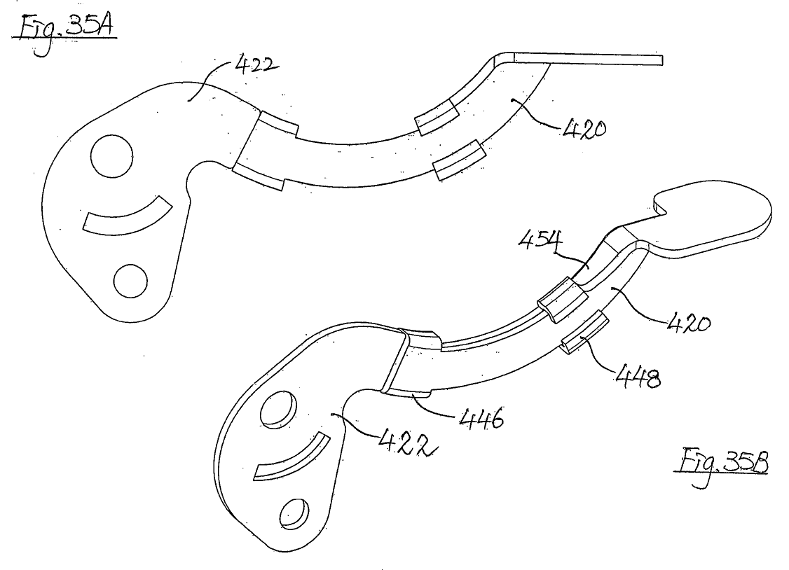

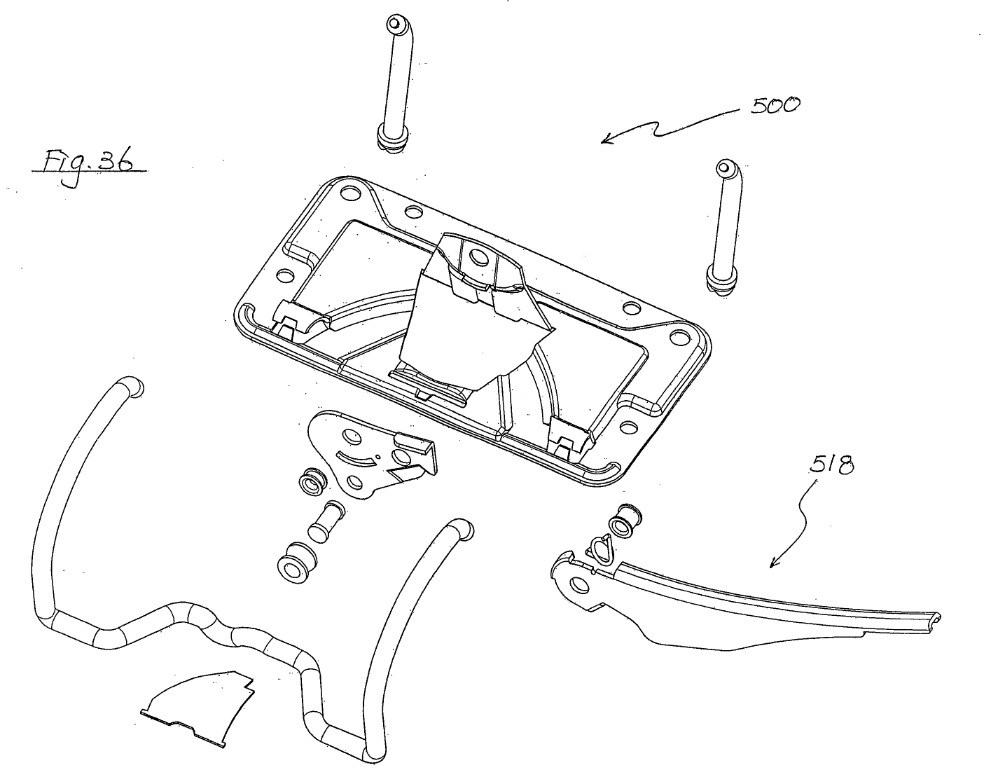

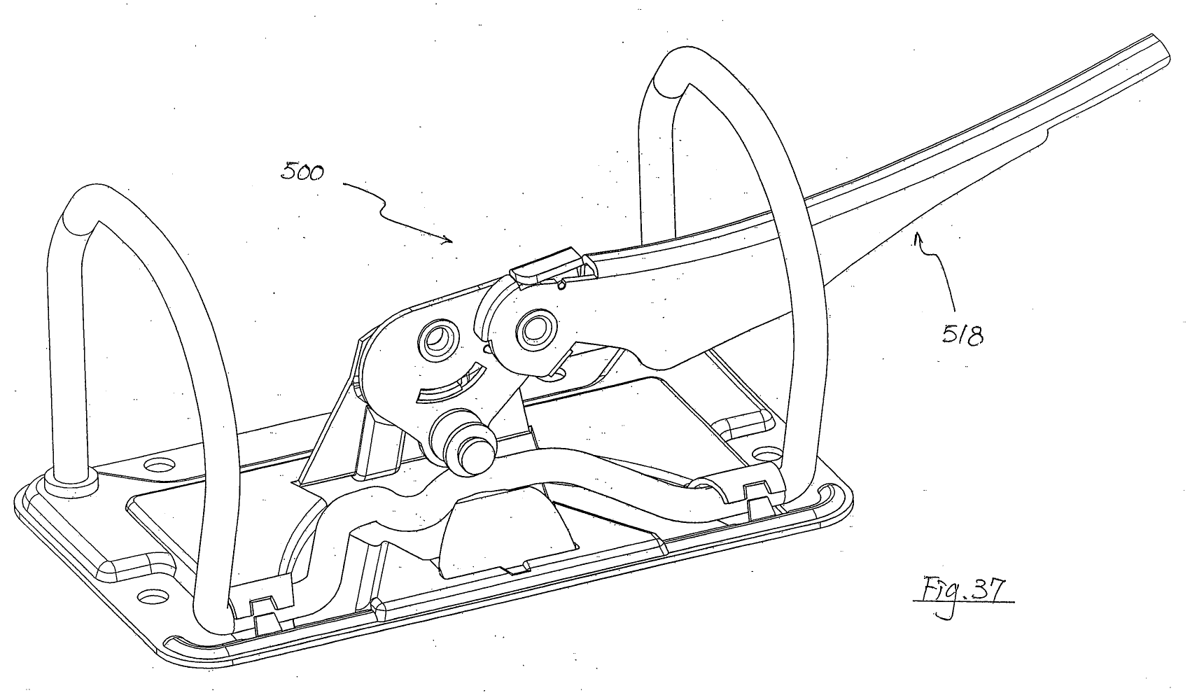

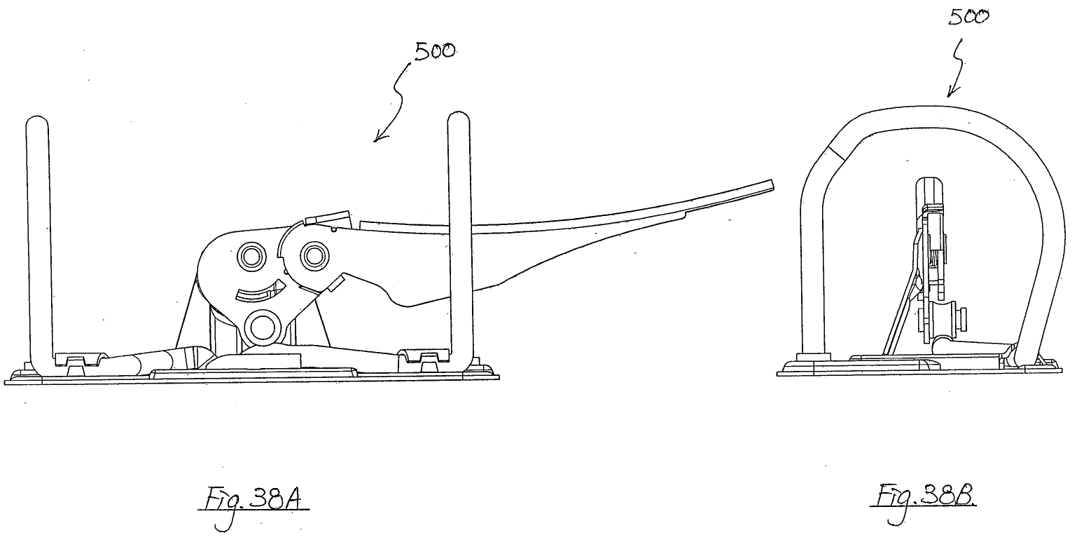

FIG. 8 is a front top perspective view of the file mechanism shown in FIG. 7A:

FIG. 9 is a rear top perspective view of the file mechanism shown in FIG. 8;

FIG. 10 is a sectioned top perspective view of the file mechanism shown in FIG. 8;

FIG. 11 is an exploded view of the lever assembly of the file mechanism shown in FIG. 1;

FIG. 12 is a perspective assembled view of the lever assembly shown in FIG. 11;

FIG. 13A is a front view of the lever assembly shown in FIG. 12 in a fully extended configuration;

FIG. 13B is a front view of the lever assembly shown in FIG. 12 in a stable configuration;

FIG. 14 is an exploded view of a lever-arch type file mechanism according to a second embodiment of the present invention;

FIG. 15A is a front view of the file mechanism shown in FIG. 14 in a ring-closed configuration, with the outer arm of the lever assembly in an upper extended position;

FIG. 15B is a top view of the file mechanism shown in FIG. 15A;

FIG. 15C is a right side view of the file mechanism shown in FIG. 15A;

FIG. 15D is a left side view of the file mechanism shown in FIG. 15A;

FIG. 16A is a front view of the file mechanism shown in FIG. 15A with the outer arm of the lever assembly in a stable lower position;

FIG. 16B is a top view of the file mechanism shown in FIG. 16A;

FIG. 16C is a right side view of the file mechanism shown in FIG. 16A:

FIG. 16D is a left side view of the file mechanism shown in FIG. 16A:

FIG. 17A is a front view of the file mechanism shown in FIG. 14 in a ring-open configuration;

FIG. 17B is a top view of the file mechanism shown in FIG. 17A;

FIG. 17C is a right side view of the file mechanism shown in FIG. 17A;

FIG. 17D is a left side view of the file mechanism shown in FIG. 17A;

FIG. 18 is an exploded view of a lever-arch type file mechanism according to a third embodiment of the present invention;

FIG. 19 is a front view of the file mechanism shown in FIG. 18 in a ring-closed configuration in which the outer arm of the lever assembly is in an upper extended position;

FIG. 20 is a side view of the file mechanism shown in FIG. 19;

FIG. 21 is a front view of the file mechanism shown in FIG. 19 in which the outer arm of the lever assembly is in a lower retracted stable position;

FIG. 22 is a side view of the file mechanism shown in FIG. 21;

FIG. 23A is a front view of the file mechanism shown in FIG. 19 in a ring-open configuration;

FIG. 23B is a side view of the file mechanism shown in FIG. 23A;

FIG. 24A is a front view of the file mechanism shown in FIG. 23A in which the outer arm of the lever assembly is in a retracted stable position;

FIG. 24B is a side view of the file mechanism shown in FIG. 24A;

FIG. 25 is an exploded view of the lever assembly of the file mechanism shown in FIG. 18;

FIG. 26A is a front view of the lever assembly shown in FIG. 25, as assembled, with the outer arm in an upper extended position;

FIG. 26B is a perspective view of the lever assembly shown in FIG. 26A;

FIG. 27A is a front view of the lever assembly shown in FIG. 26, with the outer arm in a retracted stable lower position;

FIG. 27B is a perspective view of the lever assembly shown in FIG. 27A:

FIG. 28 is an exploded view of a lever-arch type file mechanism according to a fourth embodiment of the present invention;

FIG. 29A is a front view of the file mechanism shown in FIG. 28, in a ring-closed configuration, with the outer arm of the lever assembly in an upper extended position;

FIG. 29B is a side view of the file mechanism shown in FIG. 29A;

FIG. 30A is a front view of the file mechanism shown in FIG. 29A, with the outer arm of the lever assembly in a lower retracted stable position;

FIG. 30B is a side view of the file mechanism shown in FIG. 30A;

FIG. 31A is a front view of the file mechanism shown in FIG. 29A in a ring-open configuration, with the outer arm of the lever assembly in an upper position;

FIG. 31B is a side view of the file mechanism shown in FIG. 31A;

FIG. 32A is a front view of the file mechanism shown in FIG. 31A, with the outer arm of the lever assembly in a lower retracted stable position;

FIG. 32B is a side view of the file mechanism shown in FIG. 32A;

FIG. 33 is an exploded view of the lever assembly of the file mechanism shown in FIG. 29A;

FIG. 34A is a front view of the lever assembly shown in FIG. 33, with the outer arm in an upper extended position;

FIG. 34B is a perspective view of the lever assembly shown in FIG. 34A;

FIG. 35A is a front view of the lever assembly shown in FIG. 34A, with the outer arm in a lower retracted stable position;

FIG. 35B is a perspective view of the lever assembly shown in FIG. 35A;

FIG. 36 is an exploded view of a lever-arch type file mechanism according to a fifth embodiment of the present invention;

FIG. 37 is a perspective view of the file mechanism shown in FIG. 36, in a ring-closed configuration;

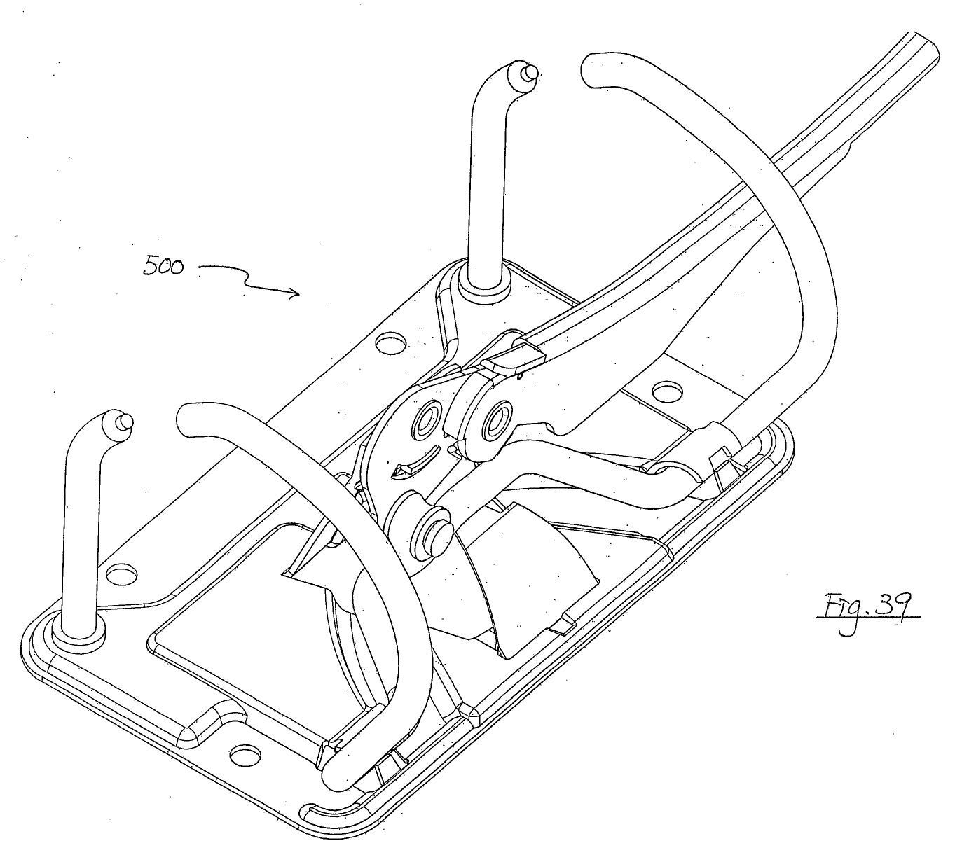

FIG. 38A is a front view of the file mechanism shown in FIG. 37;

FIG. 38B is a side view of the file mechanism shown in FIG. 38A;

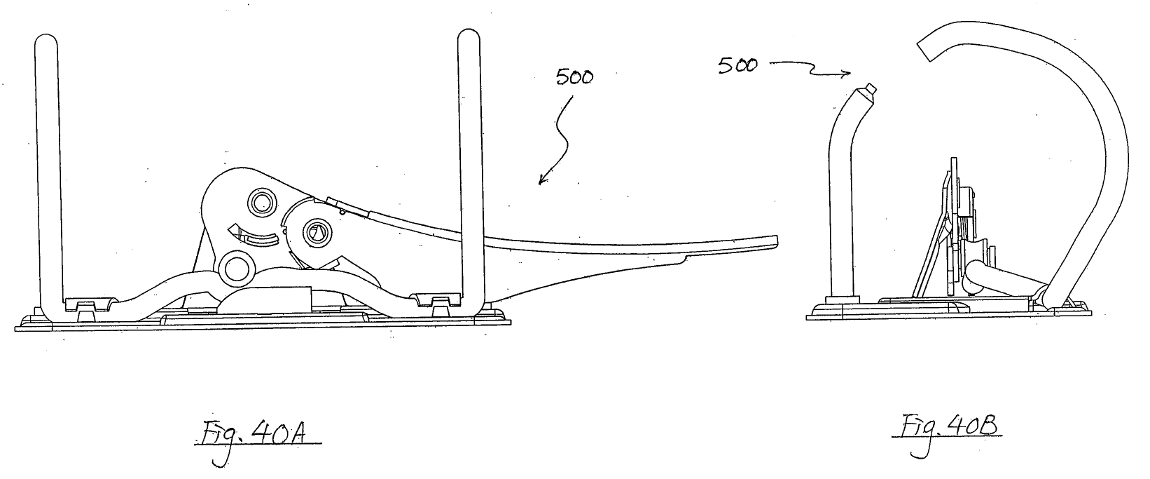

FIG. 39 is a perspective view of the file mechanism shown in FIG. 36, in a ring-open configuration;

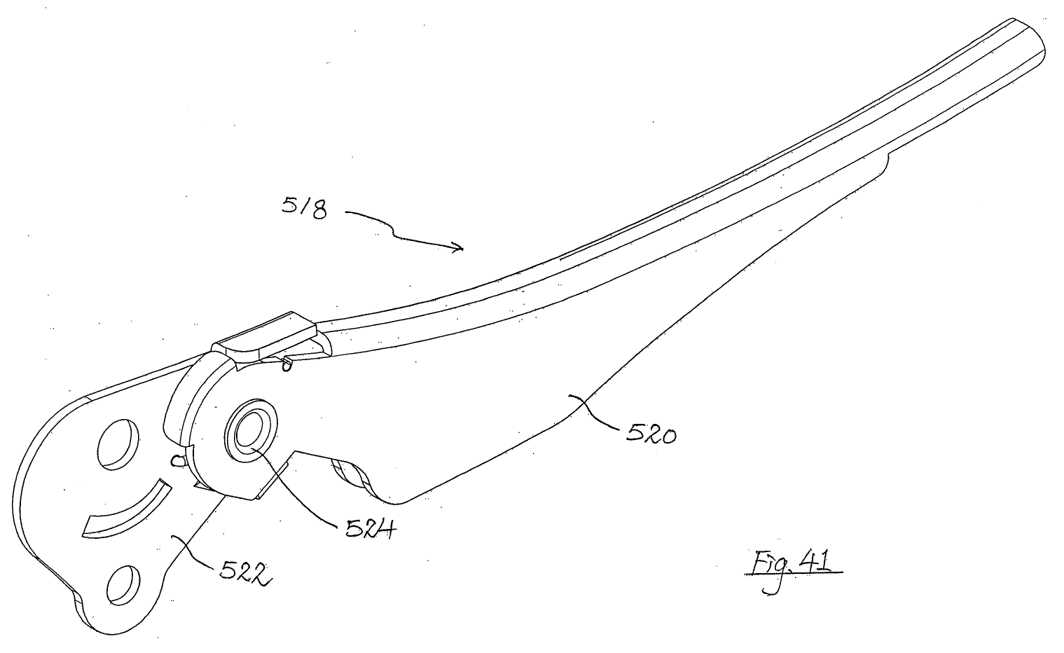

FIG. 40A is a front view of the file mechanism shown in FIG. 39;

FIG. 40B is a side view of the file mechanism shown in FIG. 40A;

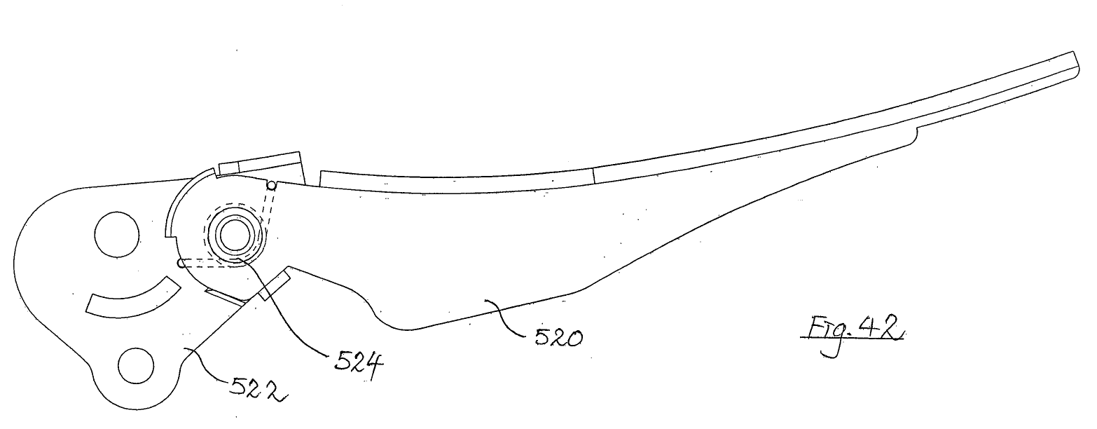

FIG. 41 is a perspective view of the lever assembly of the file mechanism shown in FIG. 37;

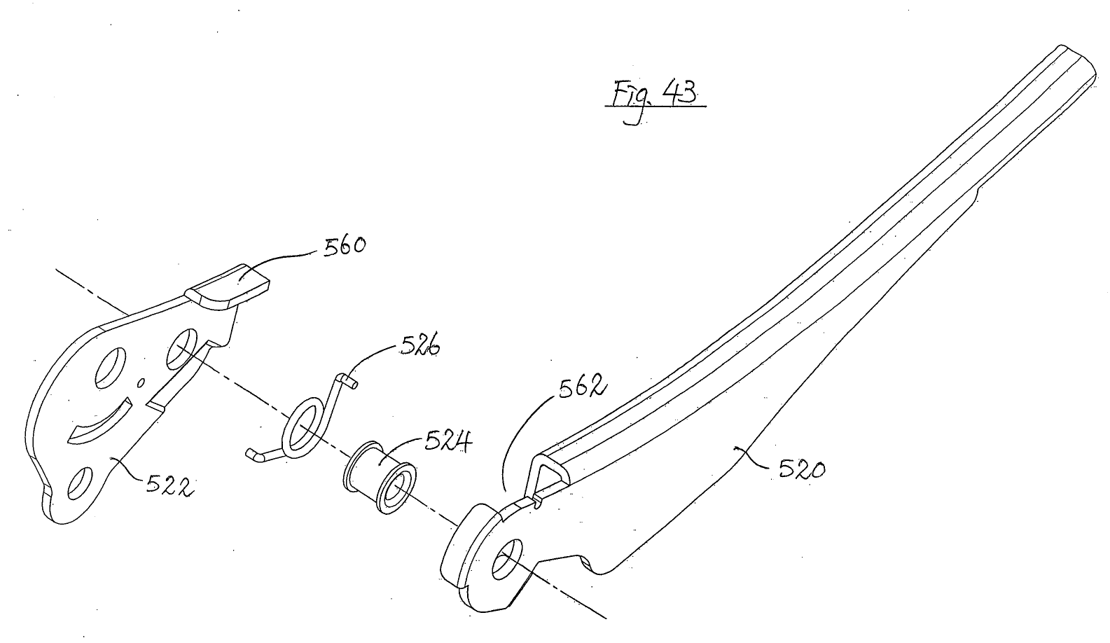

FIG. 42 is a front view of the lever assembly shown in FIG. 41;

FIG. 43 is an exploded view of the lever assembly shown in FIG. 41;

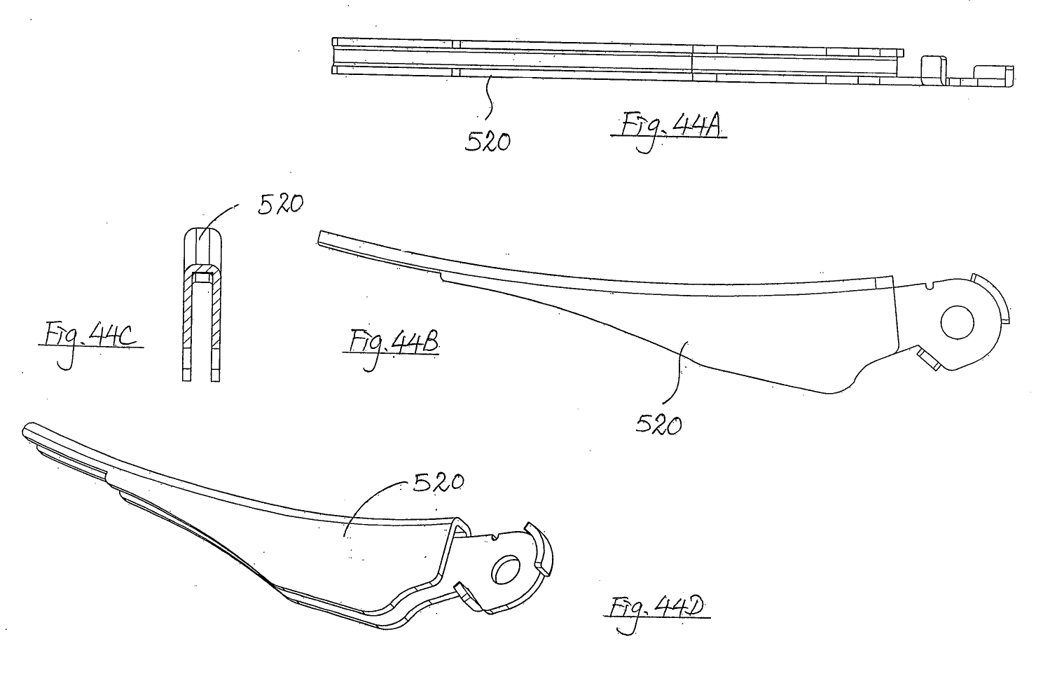

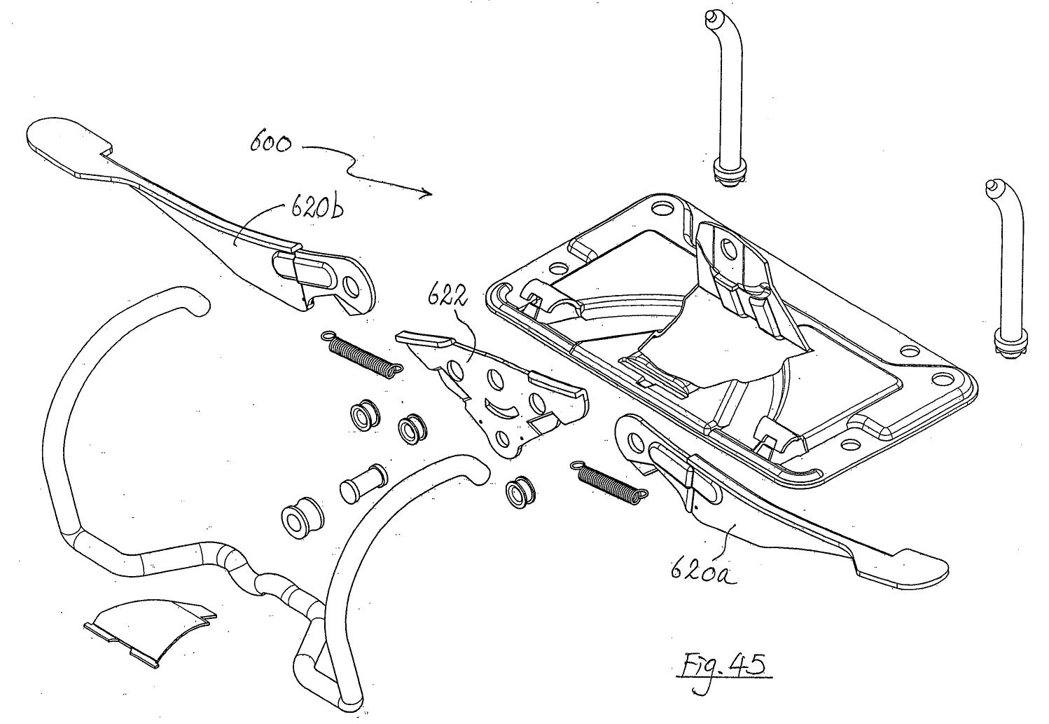

FIG. 44A is a bottom view of the outer arm of the lever assembly shown in FIG. 41;

FIG. 44B is a front view of the outer arm shown in FIG. 44A;

FIG. 44C is an end view of the outer arm shown in FIG. 44A;

FIG. 44D is a perspective view of the outer arm shown in FIG. 44A;

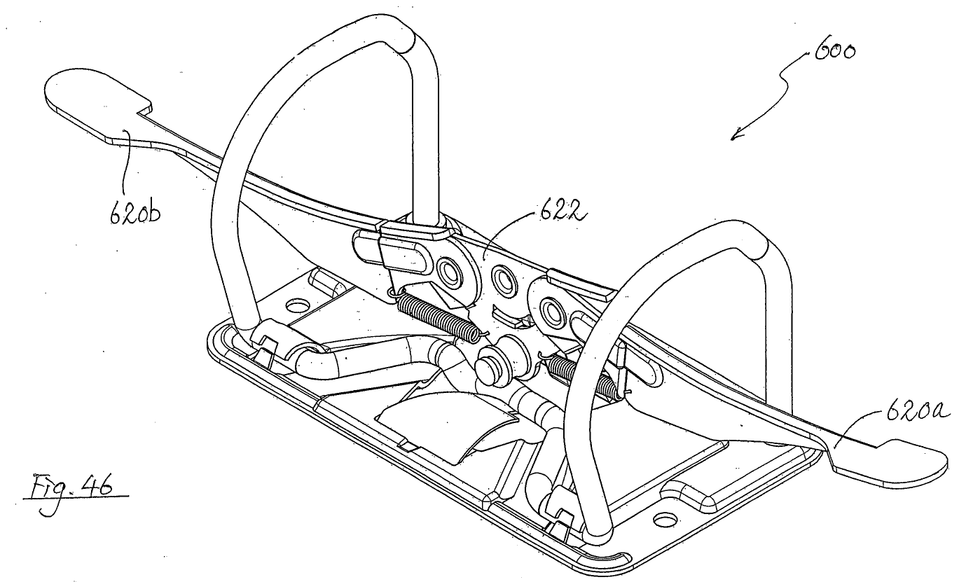

FIG. 45 is an exploded view of a lever-arch type file mechanism according to a sixth embodiment of the present invention;

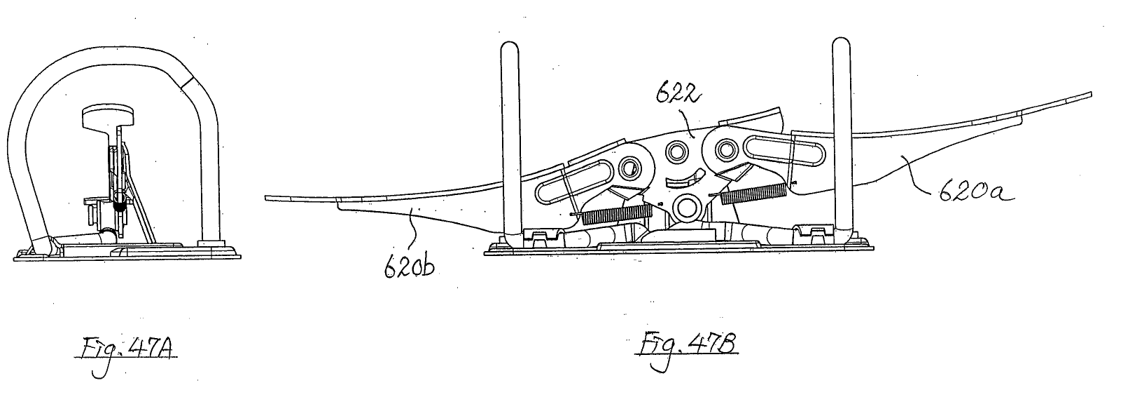

FIG. 46 is a perspective view of the file mechanism shown in FIG. 45, in a ring-closed configuration;

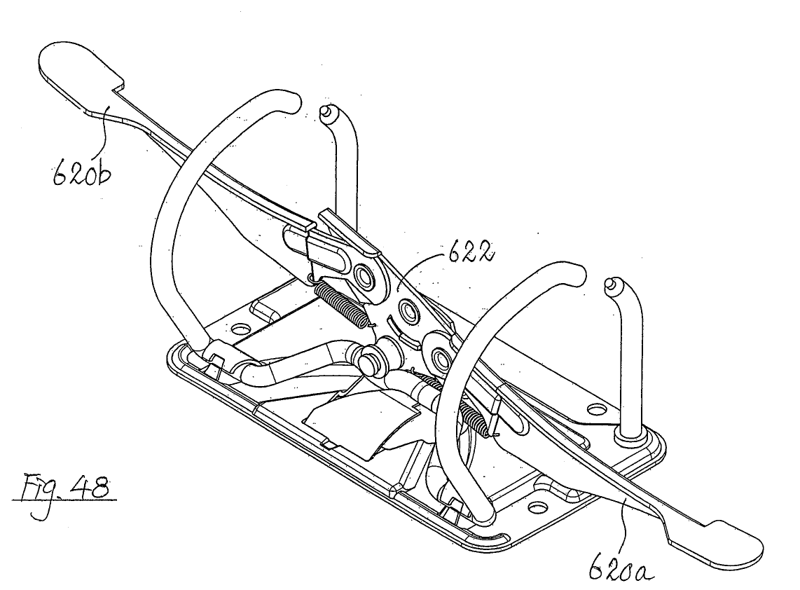

FIG. 47A is a side view of the file mechanism shown in FIG. 46;

FIG. 47B is a front view of the file mechanism shown in FIG. 47A;

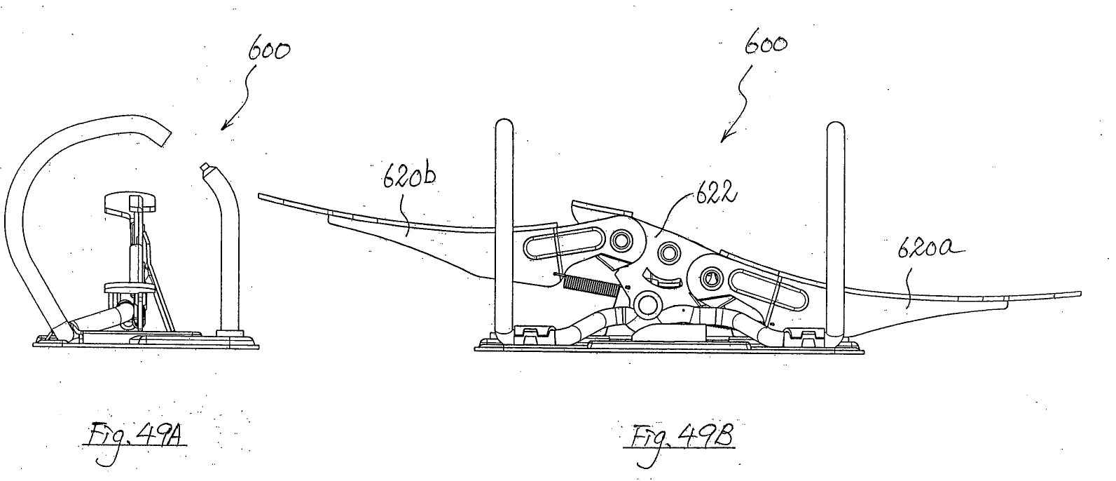

FIG. 48 is a perspective view of the file mechanism shown in FIG. 46, in a ring-open configuration;

FIG. 49A is a side view of the file mechanism shown in FIG. 48;

FIG. 49B is a front view of the file mechanism shown in FIG. 49A;

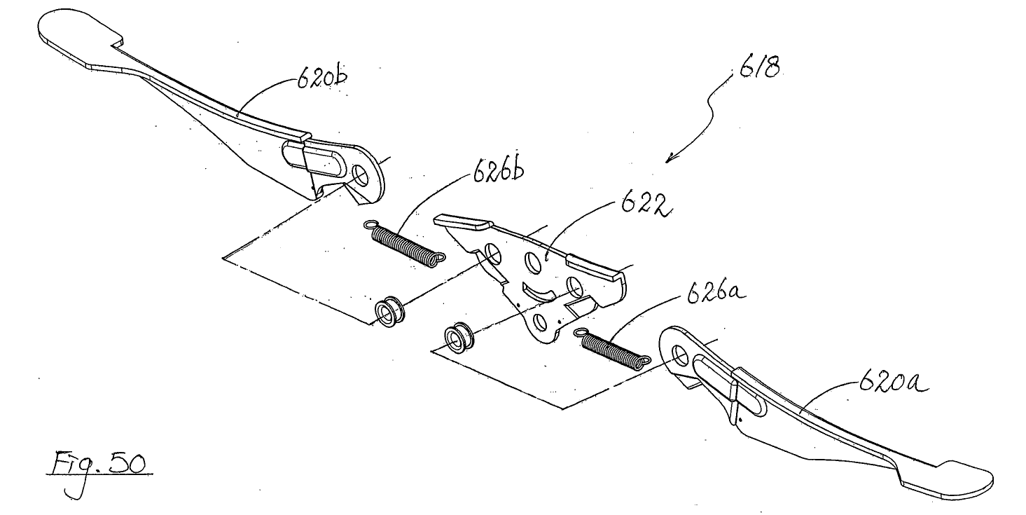

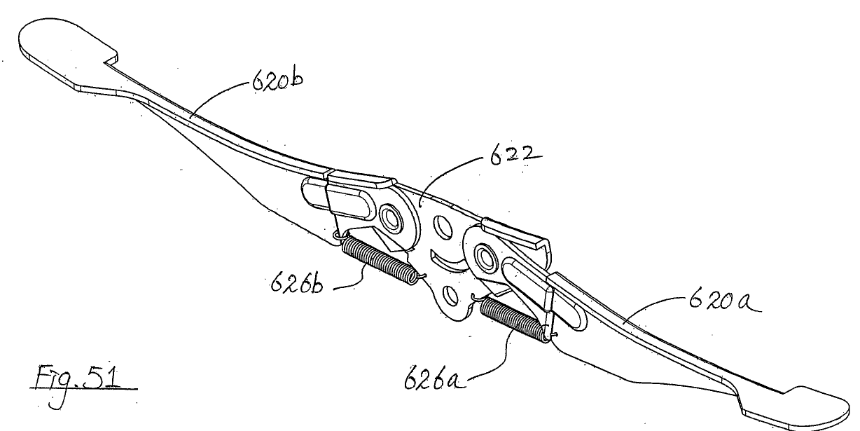

FIG. 50 is an exploded view of the lever assembly of the file mechanism shown in FIG. 45;

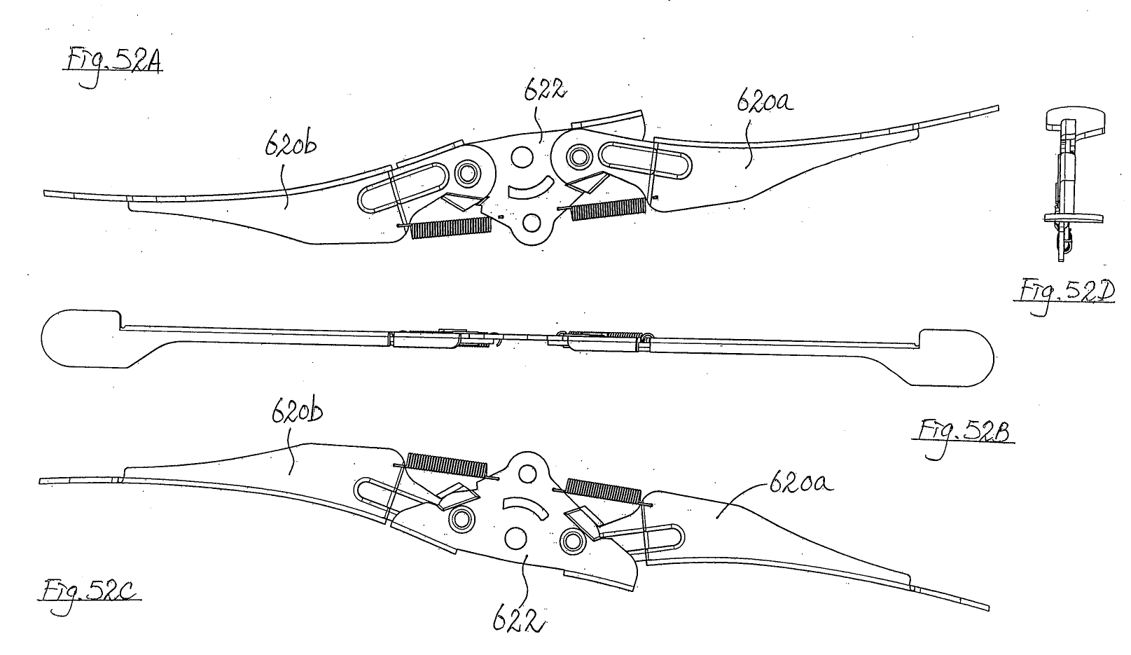

FIG. 51 is a perspective assembled view of the lever assembly shown in FIG. 50;

FIG. 52A is a front view of the lever assembly shown in FIG. 51;

FIG. 52B is a top view of the lever assembly shown in FIG. 52A;

FIG. 52C is a rear view of the lever assembly shown in FIG. 52A;

FIG. 52D is an end view of the lever assembly shown in FIG. 52A;

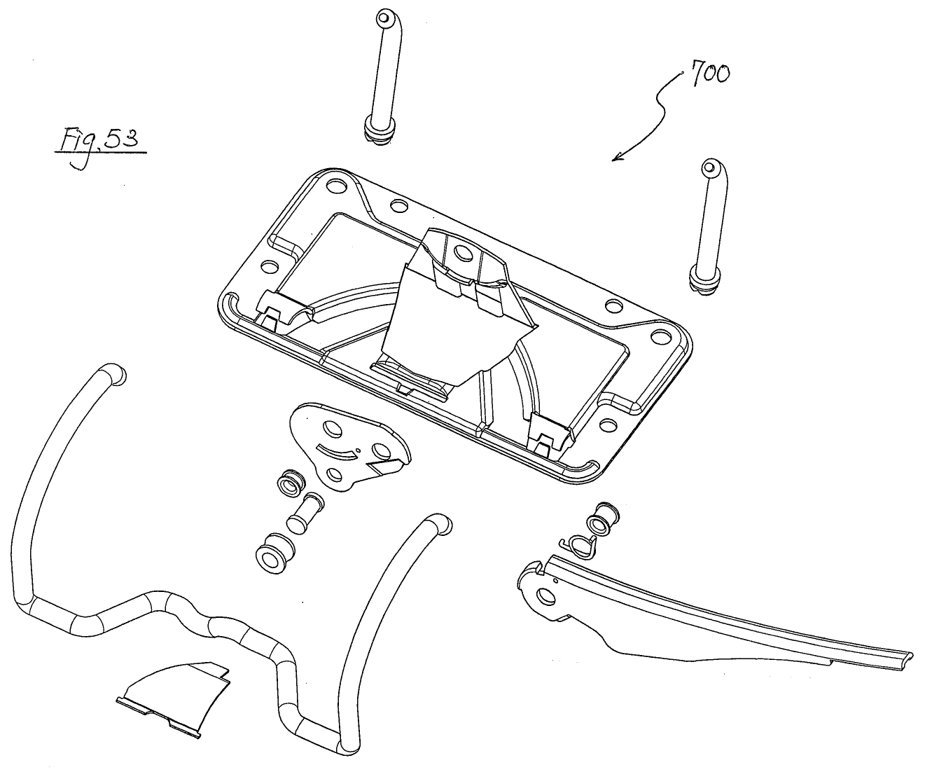

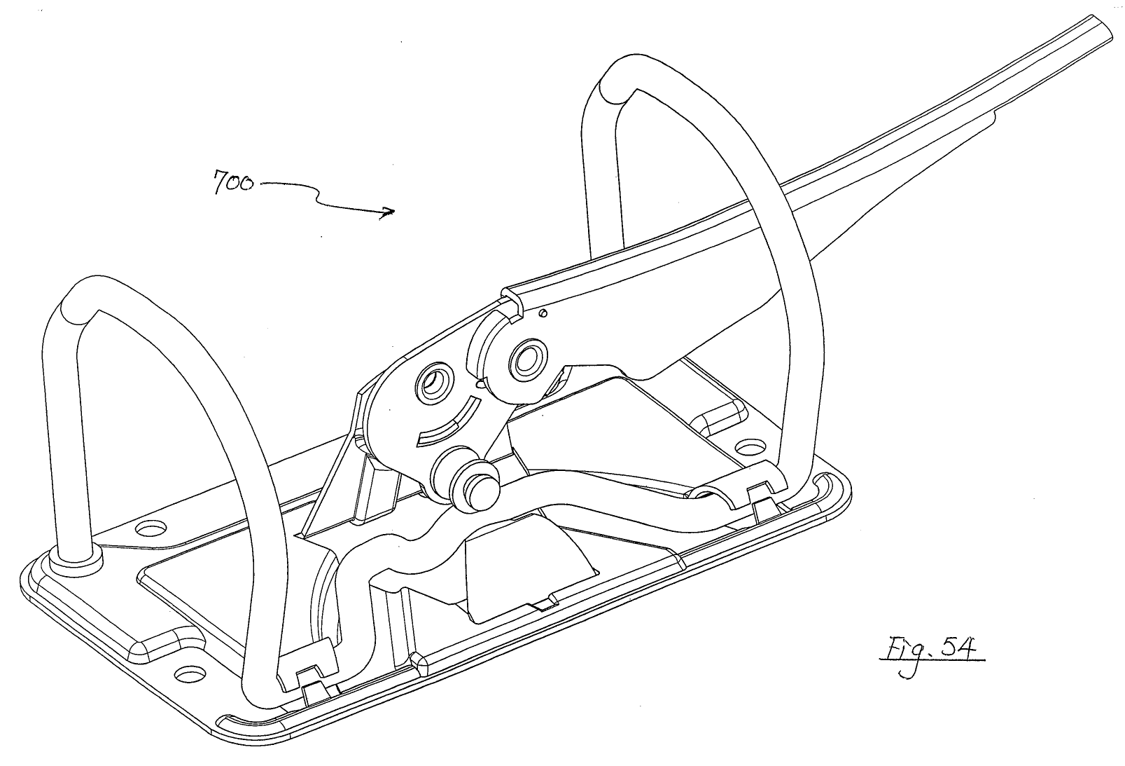

FIG. 53 is an exploded view of a lever-arch type file mechanism according to a seventh embodiment of the present invention;

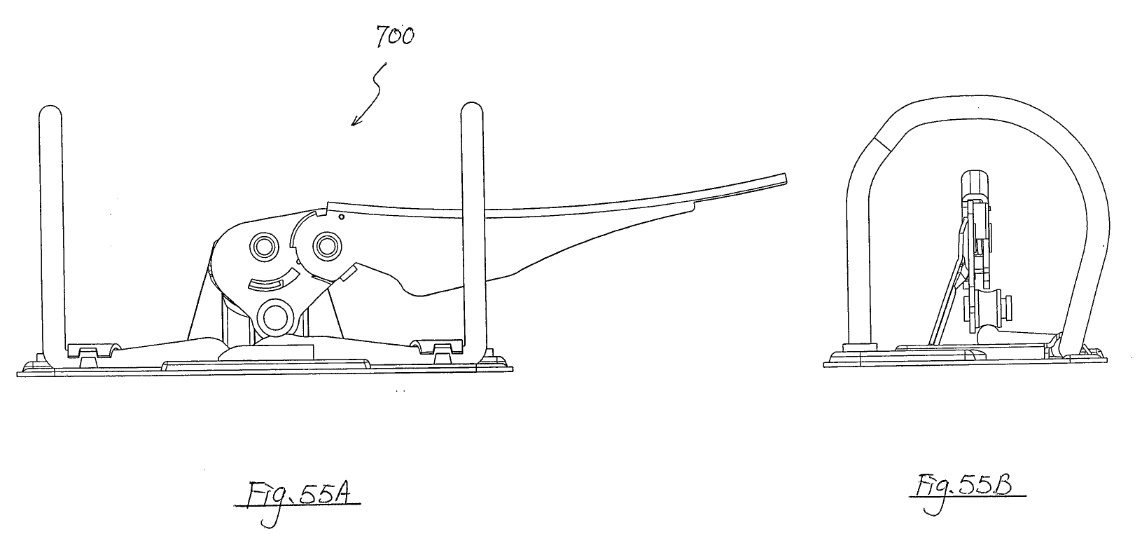

FIG. 54 is a perspective view of the file mechanism shown in FIG. 53, in a ring-closed configuration;

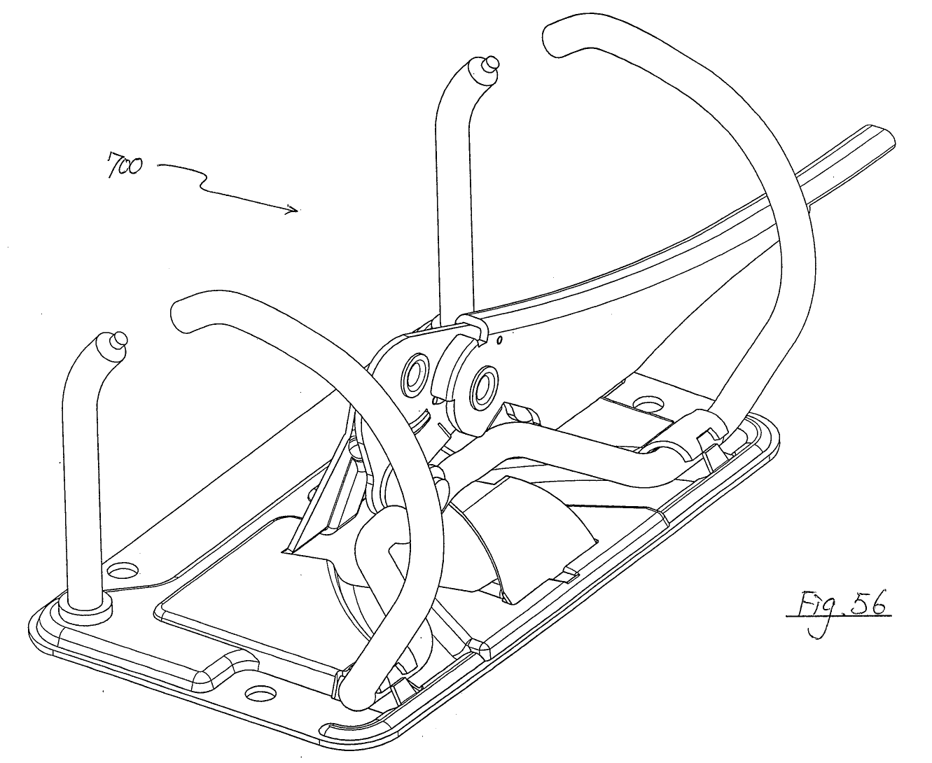

FIG. 55A is a front view of the file mechanism shown in FIG. 54;

FIG. 55B is a side view of the file mechanism shown in FIG. 55A;

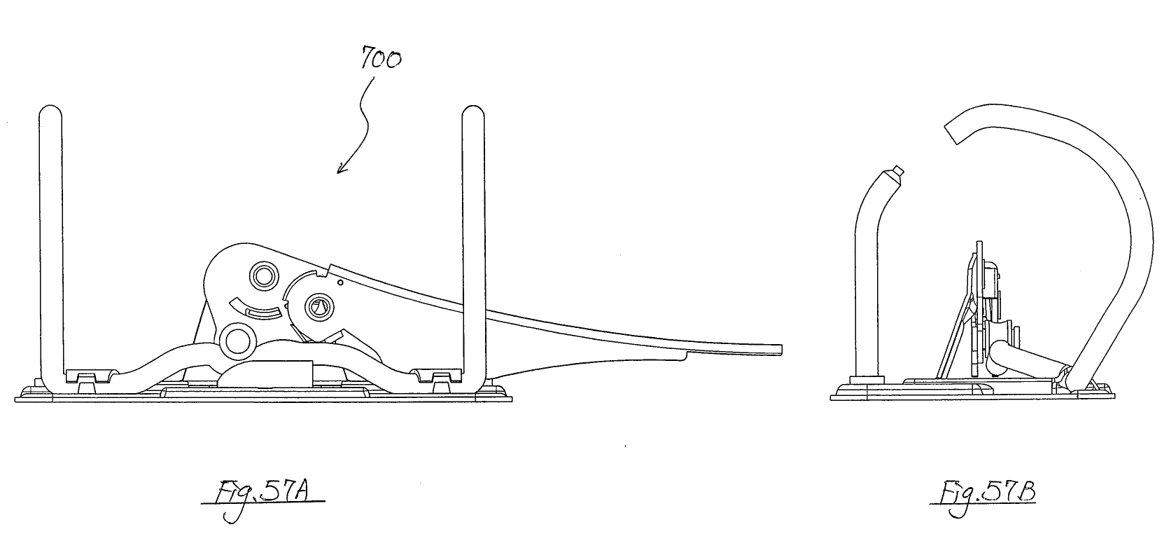

FIG. 56 is a perspective view of the file mechanism shown in FIG. 53, in a ring-open configuration;

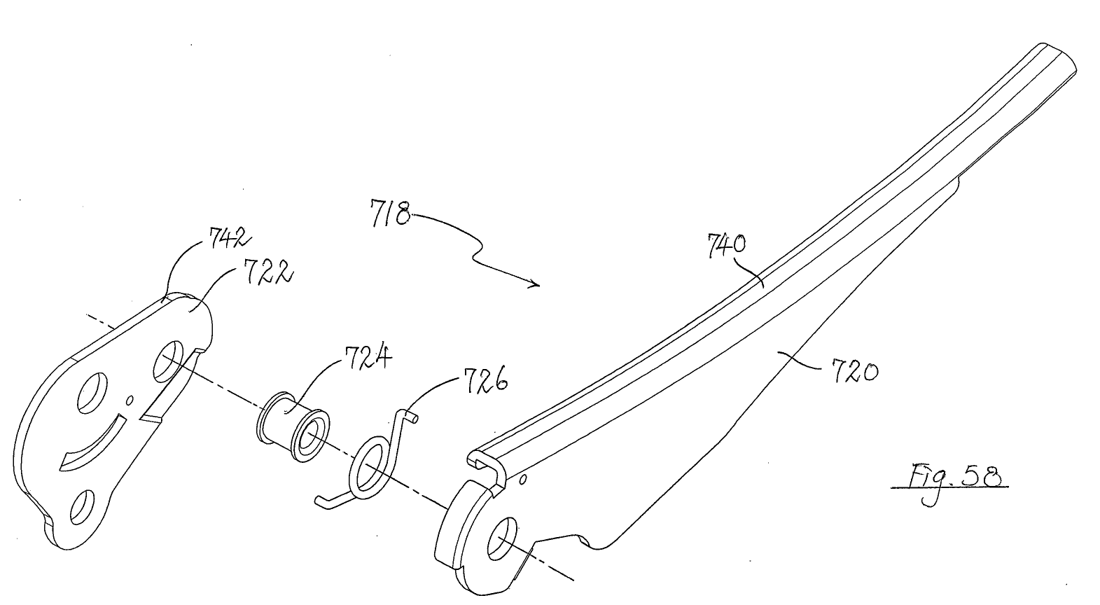

FIG. 57A is a front view of the file mechanism shown in FIG. 56;

FIG. 57B is a side view of the file mechanism shown in FIG. 57A;

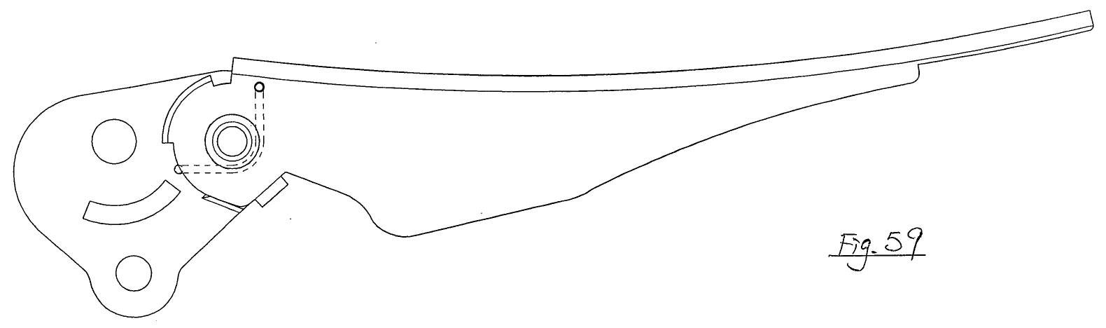

FIG. 58 is an exploded view of the lever assembly of the file mechanism shown in FIG. 54;

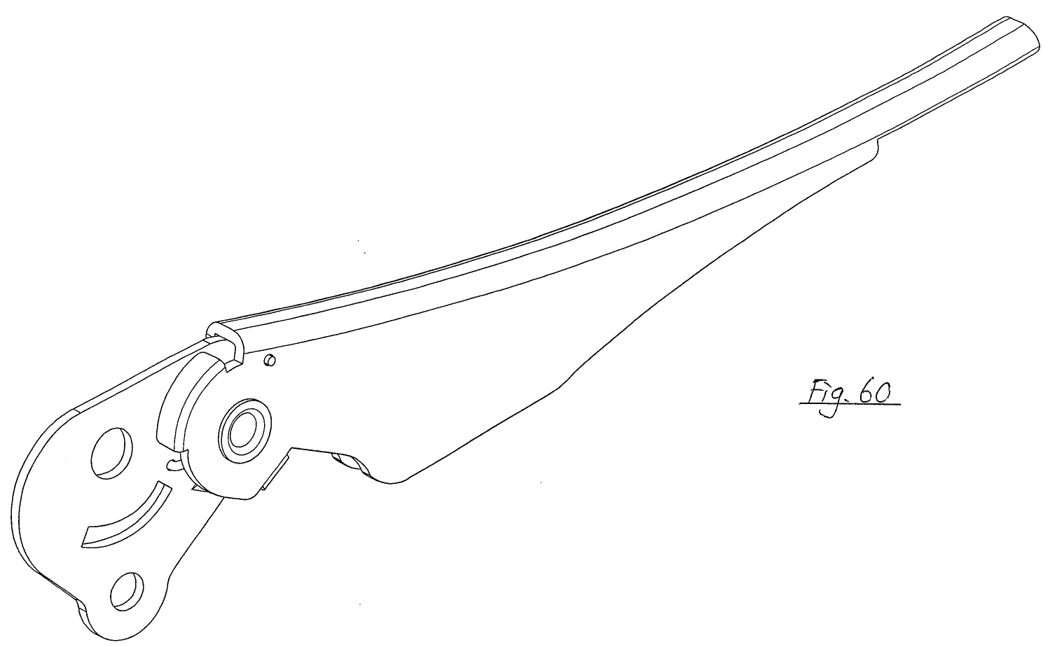

FIG. 59 is a front assembled view of the lever assembly shown in FIG. 58 in a stable configuration;

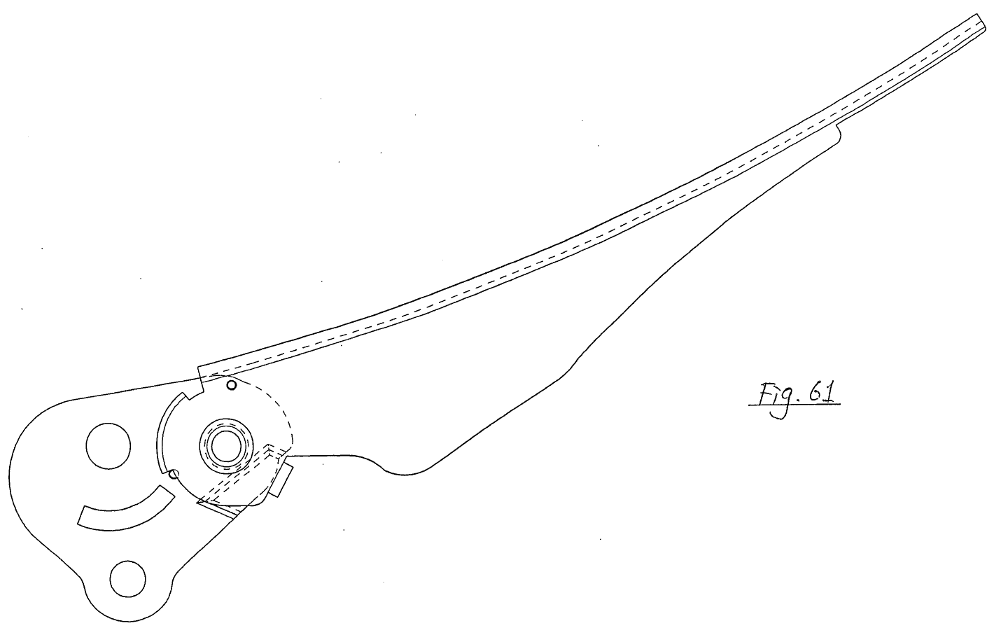

FIG. 60 is a perspective view of the lever assembly shown in FIG. 59;

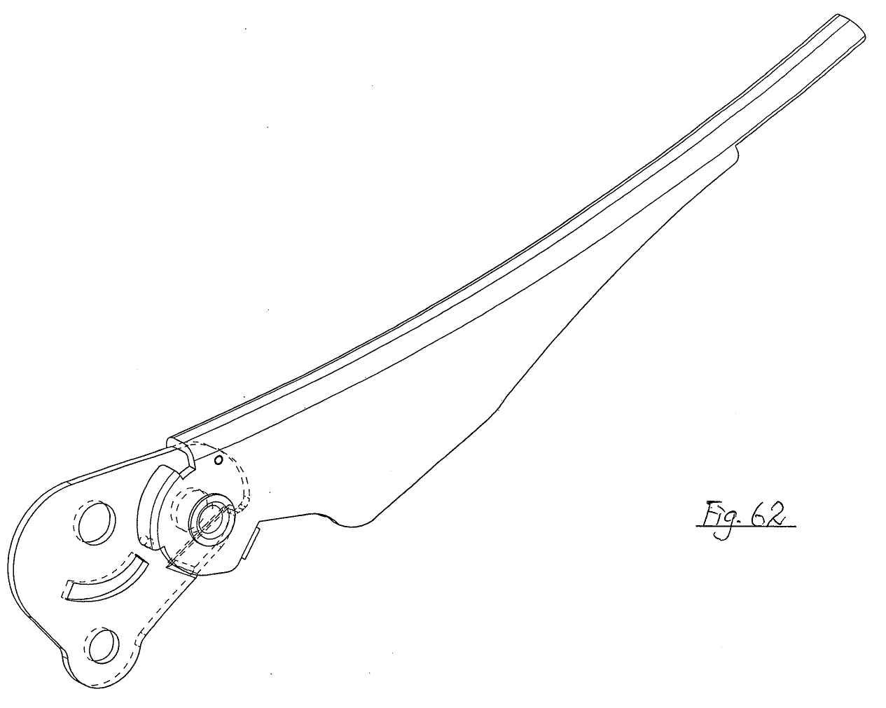

FIG. 61 is a front assembled view of the lever assembly shown in FIG. 58 in a fully extended configuration;

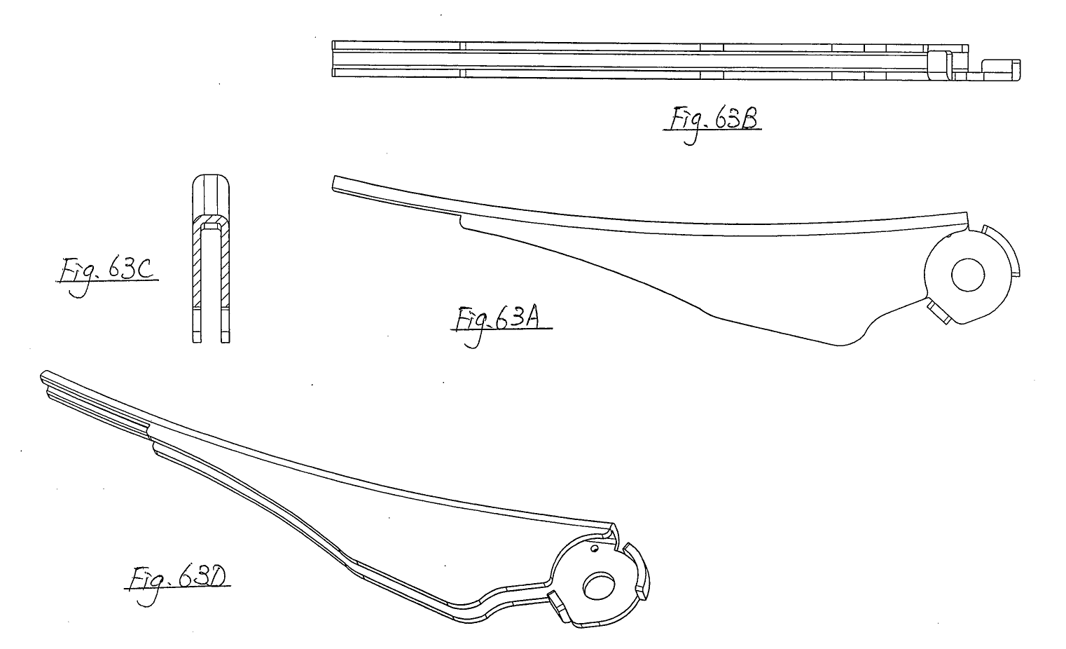

FIG. 62 is a perspective view of the lever assembly shown in FIG. 61;

FIG. 63A is a rear view of the outer arm of the lever assembly shown in FIG. 58;

FIG. 63B is a bottom view of the outer arm shown in FIG. 63A;

FIG. 63C is a side view of the outer arm shown in FIG. 63A; and

FIG. 63D is a rear perspective view of the outer arm shown in FIG. 63A.

A lever-arch type file mechanism according to a first embodiment of the present invention is shown in FIGS. 1 to 5, and generally designated as 100. The mechanism 100 includes a generally flat base 102 with an upstanding wall 104 extending generally perpendicular from the base 102. The wall 104 is integrally formed with the base 102, e.g. being stamped and bent out from a same metal sheet. Two posts 106 are fixedly engaged with, and are thus not movable relative to, the base 102.

A resilient spring leaf 108 has a first side 110 which is engaged with the base 102, and an opposite second side 112 which acts on an under side of an intervening shaped portion 114 between two arch portions 116. A lever assembly 118 is engaged with the wall 104, the function and purpose of which will be discussed below.

As shown more clearly in FIG. 6, the lever assembly 118 has an outer arm 120 pivotally engaged with an inner arm 122 about a rivet 124. The outer arm 120 is also connected with the inner arm 122 via a spring 126. By way of such an arrangement, the outer arm 120 is swivellable relative to the inner arm 122. The inner arm 122 is also pivotally engaged with the wall 104 via a rivet 128, which allows the inner arm 122 to swivel relative to the wall 104.

A lower end of the inner arm 122 carries a roller 130 which travels on and along the shaped portion 114. In particular, when the lever assembly 118 is in the upper stable position as shown in FIGS. 2A to 6, the free ends of the posts 106 and arch portions 116 mate with each other to form two closed rings extending upwardly from the base 102. The lever assembly 118 may be pivoted downwardly to the lower stable position as shown in FIGS. 7A to 10, in which the roller 130 travels to a trough portion 132 of the shaped portion 114, allowing the spring leaf 108 (which exerts an upward biasing force on an underside of the shaped portion 114) to pivot upwardly, and cause the shaped portion 114, and thus the arch portions 116, to pivot relative to the base 102 and the posts 106, and in particular away from the posts 106 to open the rings. In such a ring-open configuration, pieces of hole-punched paper (not shown) may be inserted into or retrieved from the posts 106 and the arch portions 116.

As shown more clearly in FIGS. 7A and 10, the inner arm 122 has a curved slot 134 in which is received a protrusion 136 of the wall 104 for relative sliding movement, to limit the extent of pivotal movement of the inner arm 122 relative to the wall 104.

The structure of the lever assembly 118 is shown more clearly in FIGS. 11 and 12. When the lever assembly 118 is to be pivoted upwardly, the outer arm 120 may be acted on by a finger of a user to pivot upwardly, until the outer arm 120 reaches its upper position in which it acts on an underside of a ledge 138 of the inner arm 122 to pivot the inner arm 122 upwardly. On the other hand, when the lever assembly 118 is to be pivoted downwardly, the outer arm 120 may be acted on by a finger of a user to pivot downwardly, to also cause the inner arm 122 to pivot downwardly. It should be noted that the spring 126 is arranged such that it biases the outer arm 120 towards the stable lower position shown in FIGS. 12 and 13B.

The significance of the aforesaid arrangement can best be seen from FIG. 2A, in which the dotted line 120a signifies the position of the upper edge of the outer arm 120 had the outer arm 120 and the inner arm 122 been made of one piece. Thus, by way of such an arrangement, when the lever assembly 118 is to be pivoted upwardly from the lower stable position shown in FIG. 7A to the upper stable position shown in FIG. 2A, the full length, and thus the full leverage, of the lever assembly 118 (i.e. including the outer arm 120 and the inner arm 118) can be utilized, thus facilitating the upward pivoting action. On the other hand, when the lever assembly 118 is in the upper position, the outer arm 120 will be moved from its upper position to remain in its lower position as shown in FIG. 2A by the biasing force of the spring 126. In this position, when the outer arm 120 is further away from the ring closer to it than when the outer arm 120 is in its upper position shown in dotted line, pieces of hole-punched paper retained by the rings formed by the posts 106 and arch portions 116 may be moved freely between the posts 106 and the arch portions 116. It can be seen that the outer arm 120 is movable relative to the inner arm 122 without changing the rings from a ring-closed configuration to a ring-open configuration or vice versa. In particular, the relative position between the posts 106 and the arch portions 116, and the relative position between the wall 104 and the inner arm 122, are not changed during movement of the outer arm 120 relative to the inner arm 122.

The file mechanism 100 may be fixedly secured, e.g. by rivets, to a substrate, e.g. a cardboard (not shown), to form a lever-arch type file.

A lever-arch type file mechanism according to a second embodiment of the present invention is shown in FIGS. 14 to 17D, and generally designated as 200. The file mechanism 200 is similar in structure to the lever-arch type file mechanism 100 discussed above. A main difference between the file mechanisms 100 and 200 is that, in a lever assembly 218 of the file mechanism 200, there is no spring connecting the outer arm 220 and the inner arm 222. Thus, when there is no upwardly acting force acting on the outer arm 220, and when in the ring-closed configuration when the lever assembly 218 is in its upper position, the outer arm 220 will pivot, on its own weight, downwardly from the upper position shown in FIGS. 15A to 15D to the lower stable position shown in FIGS. 16A to 16D. Again, the outer arm 200 is movable relative to the inner arm 222 without changing (a) the configuration of the rings, (b) the relative position between the inner arm 222 and an upstanding wall 204 of the file mechanism 200, nor (c) the relative position between the inner arm 222 and the base 202.

A lever-arch type file mechanism according to a third embodiment of the present invention is shown in FIGS. 18 to 24D, and generally designated as 300. The file mechanism 300 is structurally generally similar to the file mechanisms 100, 200 discussed above, with the main difference residing in the lever assembly 318. As shown in FIG. 25, the lever assembly 318 includes an outer arm 320 and an inner arm 322. The outer arm 320 has, at a first longitudinal end, a generally flat thumb plate 340 and, adjacent a second longitudinal end, a stud 342 on a side of a curved body 344. The body 344 is received and guided by two claws 346, 348 along a body 350 of the inner arm 322 for sliding movement relative to the inner arm 322 in a curve.

Thus, when the file mechanism 300 is in its ring-closed position as shown in FIGS. 19 and 20, the outer arm 320 may be moved relative to the inner arm 322 from its upper position as shown in FIGS. 19 and 20, along a curved locus, to its lower stable position as shown in FIGS. 21 and 22, in which the outer arm 320 is further away from the lower surface 352 of the arch portion 316 forming part of the ring close to it. The outer arm 320 is biased towards this lower position by its own weight.

A further feature of this file mechanism 300 is shown in FIGS. 23A to 24B in which the file mechanism 300 is shown in its ring-open configuration, and the lever assembly 318 is its lower position. The outer arm 320 may be slid from its upper extended position as shown in FIGS. 23A and 23B, along a curve, to its lower retracted stable position as shown in FIGS. 24A and 24B. The outer arm 320 is biased towards this lower position by its own weight.

It can be shown in FIGS. 26A and 26B that when the lever assembly 318 is in its fully extended configuration, the stud 342 carried by the body 344 of the outer arm 320 abuts the claw 348 of the inner arm 322 to prevent further outward movement of the outer arm 320 relative to the inner arm 322. On the other hand, as shown in FIGS. 27A and 27B, when the lever assembly is in its fully retracted configuration, a broadened part 354 of the outer arm 320 abuts the claw 346 to prevent any further inward movement of the outer arm 320 relative to the inner arm 322. Such an arrangement thus limits the extent of outward and inward movement of the outer arm 320 relative to the inner arm 322.

A lever-arch type file mechanism according to a fourth embodiment of the present invention is shown in FIGS. 28 to 32B, and generally designated as 400. The file mechanism 400 is structurally very similar to the file mechanism 300 discussed above, with the main difference residing in the lever assembly 418.

Similar to the lever assembly 318 of the file mechanism 300, the lever assembly 418 also includes an outer arm 420 and an inner arm 422 which are movable relative to each other. In particular, when the file mechanism 400 is in its ring-closed position as shown in FIGS. 29A and 29B, the outer arm 420 may be moved relative to the inner arm 422 from its upper position as shown in FIGS. 29A and 29B in which part of the outer arm 420 is above the arch portion 416 forming part of the ring closer to it, along a curved locus, to its lower position as shown in FIGS. 30A and 30B, in which the outer arm 420 is below the lower surface 452 of the arch portion 416. The outer arm 420 is biased towards this lower stable retracted position by its own weight.

As further shown in FIGS. 31A to 31B in which the file mechanism 400 is shown in its ring-open configuration, and the lever assembly 418 is its lower position, the outer arm 420 may be slid from its upper extended position as shown in FIGS. 31A and 31B, along a curved locus, to its lower stable retracted position as shown in FIGS. 32A and 32B. The outer arm 420 is biased towards this lower stable retracted position by its own weight.

The structure of the lever assembly 418 is shown more clearly in FIGS. 33 to 35B. As discussed above, the lever assembly 418 has an outer arm 420 and an inner arm 422. An inner distal end of the outer arm 420 is provided with a claw 446, and an outer distal end of the inner arm 422 is provided with a claw 448. When the inner arm 422 and the outer arm 420 are duly assembled, and as shown in FIGS. 34A and 34B, when the lever assembly 418 is in its full extended configuration, the claws 446, 448 abut with each other to prevent any further extension of the lever assembly 418. On the other hand, when the lever assembly 418 is in its fully retracted configuration, a thickened part 454 of the outer arm 420 abuts the claw 448 to prevent any further inward sliding movement of the outer arm 420 relative to the inner arm 422.

A lever-arch type file mechanism according to a fifth embodiment of the present invention is shown in FIGS. 36 to 40B, and generally designated as 500. The file mechanism 500 is structurally very similar to the file mechanism 100 discussed above, with the main difference residing in the lever assembly 518.

As in the case of the lever assembly 118 discussed in relation to the file mechanism 100 above, the lever assembly 518 has an outer arm 520 and an inner arm 522 pivotally engaged with and movable relative to each other about a rivet 524. As shown in FIG. 43, a spring 526 is provided between and enclosed by the outer arm 520 and inner arm 522 to bias the outer arm 520 and the inner arm 522 to assume the stable configuration as shown in FIG. 37 to 38B, 41 and 42. Further views showing the structure and shape of the outer arm 520 are shown in FIGS. 44A to 44D. It should be noted that the inner arm 522 has a ledge 560 which is received within a gap 562 on an upper side of the outer arm 520. Such an arrangement to limit the extent of pivotal movement between the outer arm 520 and the inner arm 522.

A lever-arch type file mechanism according to a sixth embodiment of the present invention is shown in FIGS. 45 to 49B, and generally designated as 600. This file mechanism 600 is structurally similar to the file mechanism 100 discussed above, with the major difference being that, in the lever assembly 618 of the file mechanism 600, there are two outer arms 620a, 620b pivotally engaged with a common inner arm 622.

When the file mechanism 600 is in the ring-closed configuration, as shown in FIGS. 46 to 47B, the outer arm 620a is generally upwardly extending, and the outer arm 620b is generally downwardly extending. The outer arm 620a may be pivoted downwardly to open the rings, or the outer arm 620b may be pivoted upwardly to the open the rings, to assume the ring-open configuration as shown in FIGS. 48 to 49B. Similarly, when the file mechanism 600 is in the ring-open configuration as shown in FIGS. 48 to 49B, the outer arm 620a may be pivoted upwardly, or the outer arm 620b may be pivoted downwardly, to close the rings, to assume the ring-closed configuration as shown in FIGS. 46 to 47B.

As shown more clearly in FIGS. 50 to 52D, each of the outer arms 620a, 620b is pivotally engaged with the inner arm 622 via a respective spring 626a, 626b, which bias the respective outer arms 620a, 620b towards a lowered stable position, for example, as in the relative position between the outer arm 620a and the inner arm 622 shown in FIG. 52A.

A lever-arch type file mechanism according to a seventh embodiment of the present invention is shown in FIGS. 53 to 57B, and generally designated as 700. The structure of the file mechanism 700 is very similar to that of the file mechanism 500 discussed above. As shown in FIG. 58, a lever assembly 718 of the file mechanism 700 has an outer arm 720 and an inner arm 722 pivotally engaged with and movable relative to each other about a rivet 724. A spring 726 is provided between and enclosed by the outer arm 720 and inner arm 722 to bias the outer arm 720 and the inner arm 722 to assume the stable configuration as shown in FIG. 54 to 55B, 59 and 60. Further views showing the structure and shape of the outer arm 720 are shown in FIGS. 63A to 63D. The outer arm 720 may be moved relative to the inner arm 722 against the biasing force of the spring 726 to assume the fully extended configuration shown in FIGS. 56 to 57B, 61 and 62. It can be seen that the inner arm 722 is planar and the outer arm 720 has a continuous bent upper edge 740 which covers at least part of the upper edge 742 of the inner arm 722.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A lever-arch type file mechanism including:
a base;
at least two rings extending upwardly from the base, each said ring including a post member fixed to said base and an arch member movable relative to said base and said post member;
a lever assembly movable relative to said base between two stable positions to pivot said arch members relative to said post members to selectively move said rings between a ring-closed configuration and a ring-open configuration;
wherein said lever assembly includes at least a first arm member and a second arm member and that when said lever assembly is in a first of said stable positions, said first arm member is movable relative to said second arm member between an upper position and a lower position.

2. A lever-arch type file mechanism according to claim 1, wherein said first arm member is movable relative to said second arm member between said upper position and said lower position without changing the configuration of said rings.

3. A lever-arch type file mechanism according to claim 1, wherein said first arm member moves from its upper position to its lower position, it moves away from a ring closer thereto.

4. A lever-arch type file mechanism according to claim 1, wherein said lower position of said first arm member is a stable position.

5. A lever-arch type file mechanism according to claim 1, wherein said first arm member is biased towards said lower position.

6. A lever-arch type file mechanism according to claim 5, wherein said first arm member is biased towards said lower position by its own weight.

7. A lever-arch type file mechanism according to claim 5, wherein said first arm member is biased towards said lower position by spring means.

8. A lever-arch type file mechanism according to claim 1, wherein including means for limiting the extent of relative movement between said first and second arm members.

9. A lever-arch type file mechanism according to claim 1, wherein said first arm member is pivotable relative to said second arm member.

10. A lever-arch type file mechanism according to claim 1, wherein said first arm member is slidable relative to said second arm member.

11. A lever-arch type file mechanism according to claim 10, wherein said first arm member is slidable relative to said second arm member along a curve.

12. A lever-arch type file mechanism according to claim 1, wherein when said lever assembly is in a second of said stable positions, said first arm member is movable relative to said second arm member.

13. A lever-arch type file mechanism according to claim 12, wherein said first arm member is slidable relative to said second arm member.

14. A lever-arch type file mechanism according to claim 13, wherein said first arm member is slidable relative to said second arm member along a curve.

15. A lever-arch type file mechanism according to claim 1, comprising two first arm members.

16. A lever-arch type file mechanism according to claim 15, wherein said two first arm members are pivotally engaged with a common second arm member.

17. A lever-arch type file mechanism according to claim 15, wherein a first of said two first arm members is downwardly pivotable to pivot said arch members relative to said post members to open said rings, and a second of said two first arm members is downwardly pivotable to pivot said arch members relative to said post members to close said rings.

18. A lever-arch type file including a lever-arch type file mechanism according to claim 1, fixedly secured to a substrate.
